(19) United States
(12) Patent Application Publication
(10) Pub. No.: US 2011/0292268 A1
(43) Pub. Date: Dec. 1, 2011

(54) MULTI-REGION TOUCHPAD DEVICE

(75) Inventors: Jonathan L. Mann, Seattle, WA (US); Richard Alan Ewing, JR., Renton, WA (US); Parker Ralph Kuncl, Seattle, WA (US); Michael Kemery, Seattle, WA (US); Prarthana H. Panchal, Seattle, WA (US); Benoit F. Collette, Seattle, WA (US)

(73) Assignee: T-MOBILE USA, INC., Bellevue, WA (US)

(21) Appl. No.: 12/851,421

(22) Filed: Aug. 5, 2010

Related U.S. Application Data
(63) Continuation-in-part of application No. 12/788,239, filed on May 26, 2010.

(51) Int. Cl. H04N 5/225; B62D 1/06; B62D 1/04; G06F 3/045; G09G 5/00

(52) U.S. Cl. 348/333.01; 345/174; 345/168; 74/552; 74/558; 348/E05.024

(57) ABSTRACT

Techniques utilizing a multi-region touch panel are described for implementing user interfaces in various types of devices.

### PRIORITY

This application is a continuation-in-part of and claims the benefit of U.S. patent application Ser. No. 12/788,239, filed on May 26, 2010, which is incorporated by reference herein in its entirety.

### BACKGROUND

Handheld devices have become more and more prevalent, in forms such as cellular phones, wireless phones, smartphones, music players, video players, netbooks, laptop computers, e-reading devices, tablet computers, cameras, controllers, remote controls, analytic devices, sensors, and many other types of devices.

User interfaces for handheld devices have become increasingly sophisticated, and many user interfaces now include color bitmap displays. Furthermore, many user interfaces utilize touch sensitive color displays that can detect touching by a finger or stylus. There are many varieties of touch sensitive displays, including those using capacitive sensors, resistive sensors, and active digitizers. Some displays are limited to detecting only single touches, while others are capable of sensing multiple simultaneous touches.

Touch sensitive displays are convenient in handheld devices because of the simplicity of their operation to the user. Menu items can be displayed and a user can interact directly with the menu items by touching or tapping them, without the need to position or manipulate an on-screen indicator such as a pointer, arrow, or cursor. Furthermore, the touch capabilities of the display reduce the need for additional hardware input devices such as buttons, knobs, switches, mice, pointing sticks, track pads, joysticks, and other types of input devices.

One disadvantage of touch sensitive user interfaces, however, is that a user's finger can often obstruct the user's view of the display, and repeated touching of the display can result in fingerprints and smudges that obscure the display. Furthermore, it may be awkward in some devices for a user to both hold the device and to provide accurate touch input via the display, especially with one hand. Because of this, many devices are more awkward in operation than would be desirable.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a rear perspective view of a handheld device utilizing a rear touch panel.

FIG. 2 is a rear view of the handheld device of FIG. 1, showing a possible hand and finger placement relative to a rear touch panel.

FIG. 3 is a rear view of the handheld device of FIG. 1, showing another possible hand and finger placement relative to the rear touch panel.

FIG. 4 is a front perspective view of an alternative handheld device utilizing an edge touch panel.

FIG. 5 is a front view of the handheld device of FIG. 1, showing an embodiment of a banded menu structure that can be used in conjunction with the rear touch panel shown in FIGS. 1 and 2.

FIG. 6 is a front perspective view of the handheld device of FIG. 1, showing the relationship between its rear touch panel and the banded menu structure shown in FIG. 5.

FIG. 7 is a close-up of a banded menu structure such as might be implemented in conjunction with a handheld device.

FIG. 8 is a front view of a handheld device such as shown in FIG. 1, illustrating an example of a possible user interaction with the handheld device.

FIGS. 9-15 are close-ups of banded menu configurations illustrating user interface examples.

FIG. 16 is a flowchart showing how a menu structure such as shown in FIG. 7 might be utilized in a handheld device.

FIG. 17 is a block diagram showing relevant components of a handheld device that might be used to support the menus and related components described herein.

FIG. 18 is a drawing of a general-purpose computer having a keyboard that incorporate a multi-level touchpad in accordance with the techniques described herein.

FIG. 19 is a perspective view of a portion of the keyboard shown in FIG. 18, showing more details of the multi-level touchpad.

FIG. 20 illustrates a menu structure that is used in conjunction with the touchpad shown in FIGS. 18 and 19.

FIGS. 21 and 22 illustrate a usage scenario that utilizes the touchpad and menu structure of FIGS. 18-20.

FIGS. 23 and 24 illustrate another usage scenario that utilizes the touchpad and menu structure of FIGS. 18-20.

FIGS. 25 and 26 illustrate a usage scenario that utilizes the touchpad of FIGS. 18-19.

FIG. 27 is a flowchart illustrating a generalized procedure for implementing the usage scenarios described above with reference to FIGS. 18-26.

FIG. 28 is a perspective view of a computer mouse that incorporates a multi-region touchpad.

FIG. 29 is a perspective view of a digitizer pad that incorporates a multi-region touchpad.

FIG. 30 is a perspective view of a tablet computer that incorporates a multi-region touchpad.

FIG. 31 is a perspective view of a remote control that incorporates a multi-region touchpad.

FIG. 32 is a perspective view of a game controller that incorporates a multi-region touchpad.

FIG. 33 is a perspective view of a digital camera that incorporates a multi-region touchpad.

FIG. 34 is a perspective view of an automobile interior having a steering wheel that incorporates a multi-region touchpad.

### DETAILED DESCRIPTION

### Back Touch Panel

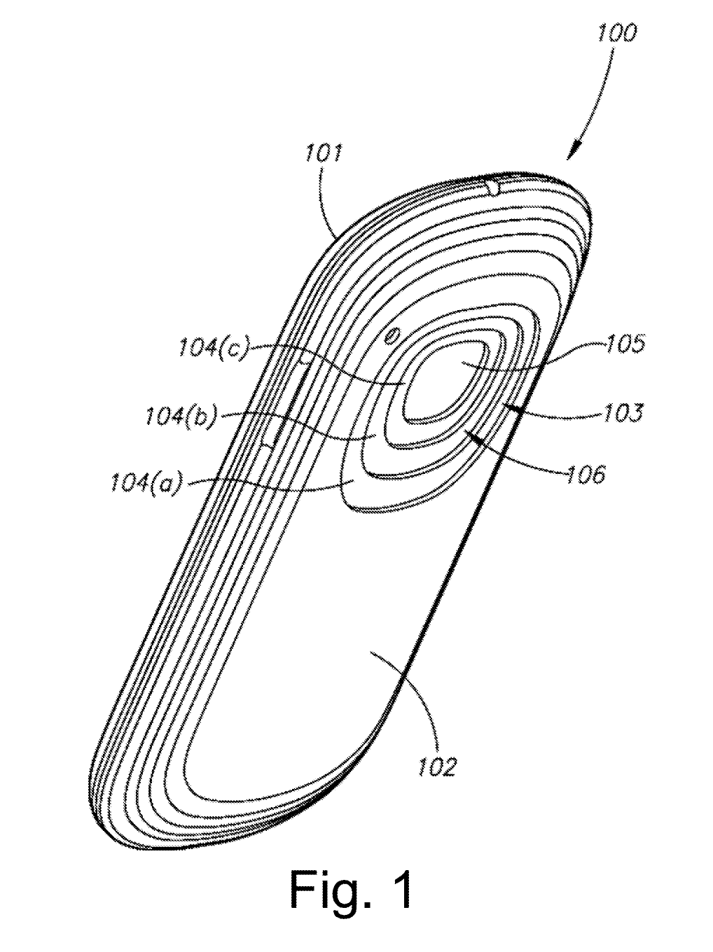

FIG. 1 shows a handheld device 100 featuring a front surface 101 (not visible in FIG. 1) and an alternate surface (in this case a back or rear surface) 102. Handheld device 100 may be held in one hand by a user, with front surface 101 facing and visible to the user. Alternate surface 102 is, in this embodiment, opposite front surface 101, and faces away from the user during typical handheld operation. In some embodiments, front surface 101 may have a display and/or other user interface elements.

Handheld device 100 has a touch sensitive sensor 103, also referred to herein as a touch panel or multi-region touchpad. Touch panel 103 is situated in the alternate surface, in this embodiment facing away from a user who is holding handheld device 100. In operation, a user's finger, such as the user's index finger, may be positioned over or on touch panel 103; touch panel 103 is positioned in such a way as to make this finger placement comfortable and convenient.

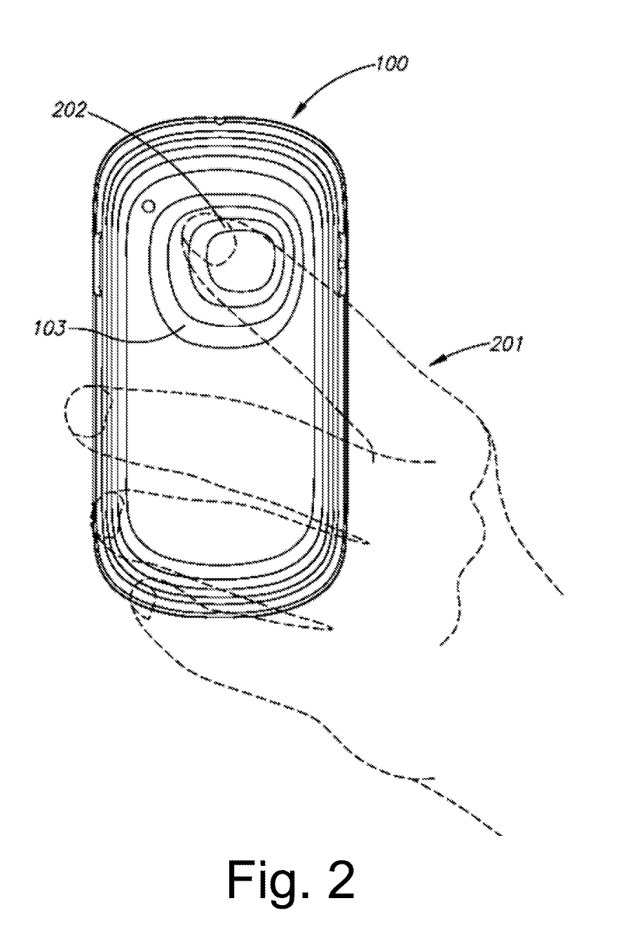

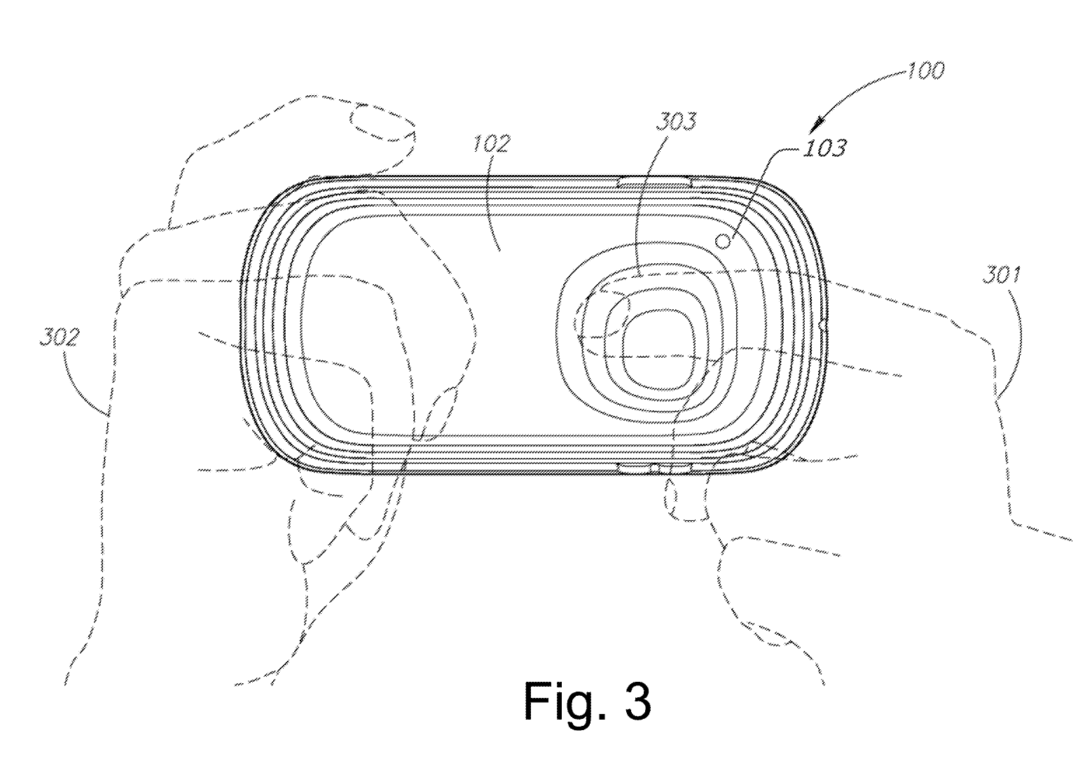

FIGS. 2 and 3 show two examples of how device 100 might be grasped by a user. In FIG. 2, the user holds device 100 with a single hand 201 in a portrait orientation, with index finger 202 positioned over touch panel 103 for operation of touch panel 103. In FIG. 3, the user holds device 100 in a landscape position with left hand 301 and right hand 302, with index finger 303 of the left hand positioned over touch panel 103.

Touch panel 103 has multiple areas that are tactually delineated from each other so that a user can distinguish between the areas by touch. In the described embodiment, the areas comprise a plurality of successively nested or hierarchically arranged annular rings or bands 104. In the illustrated example, there are three such bands: an outer band 104(a), a middle band 104(b), and an inner band 104(c). Bands 104 may be concentric in some embodiments, and may surround a common central touch area 105. Individual bands 104 may be referred to as touch bands in the following discussion.

In the described embodiment, each of bands 104 has a different elevation or depth relative to alternate surface 102 of handheld device 100. There are steps or discontinuous edges between the different elevations that provide tactile differentiation between areas or bands 104, allowing a user to reliably locate a particular touch band, via tactile feedback with a finger, without visually looking at touch panel 103.

In this example, each successively inward band is stepped down in elevation from alternate surface 102 or from its outwardly neighboring band. In particular, outer band 104(a) is stepped down from alternate surface 102 and therefore is deeper or has a lower elevation than alternate surface 102. Middle band 104(b) is stepped down from its outwardly neighboring band 104(a) and is therefore deeper and has a lower elevation than outer band 104(a). Inner band 104(c) is stepped down from its outwardly neighboring band 104(b) and is therefore deeper and has a lower elevation than middle band 104(b). Similarly, central area 105 is stepped down from surrounding inner band 104(c) and is therefore deeper and has a lower elevation than inner band 104(c). Those of skill in the art will understand that touch bands 104 may each successively extend upward from the bordering larger band. Thus, outer band 104(a) may be lower than middle band 104(b), which in turn is lower than inner band 104(c), which is in turn lower than central area 105, thus forming a convex arrangement. In another embodiment, the respective bands may all share the same level, but may be tactually detectable by virtue of a raised border between them. For purposes of simplicity, however, the disclosed embodiment will address only a concave arrangement of touchpad 103.

The progressively and inwardly increasing depths of bands 104 and central area 105 relative to alternate surface 102 create a concavity or depression 106 relative to alternate surface 102. Position and dimensions of touch panel 103 can be chosen so that a user's index finger naturally locates and rests within concavity 106, such that it is comfortable to move the finger to different locations around touch panel 103.

Bands 104 can be irregularly shaped or can form a wide variety of shapes such as circles, ovals, rectangles, or squares. In the illustrated embodiment, bands 104 are irregularly shaped to allow easy finger positioning at desired locations. The irregular shape of bands 104 allows a user to learn the orientation of the bands and thus aids in non-visual interaction with touch panel 103.

Touch panel 103 is sensitive to touch, and can detect the particular location at which it is touched or pressed. Thus, it can detect which individual band 104 is touched, and the position or coordinates along the band of the touched location. A user can slide his or her finger radially between bands 104 or around a single band 104, and touch panel 103 can detect the movement and absolute placement of the finger as it moves along or over the bands. Central area 105 is also sensitive to touch in the same manner.

Touch panel 103 can be implemented using capacitive, resistive, or pressure sensing technology, or using other technologies that can detect a user's finger placement. Touch panel 103 may also integrate additional sensors, such as sensors that detect the pressing or depression of central area 105 or other areas of touch panel 103.

Different embodiment may utilize different numbers of bands, and a single band or two bands may be used in different embodiments. Furthermore, the bands may be shaped and positioned differently.

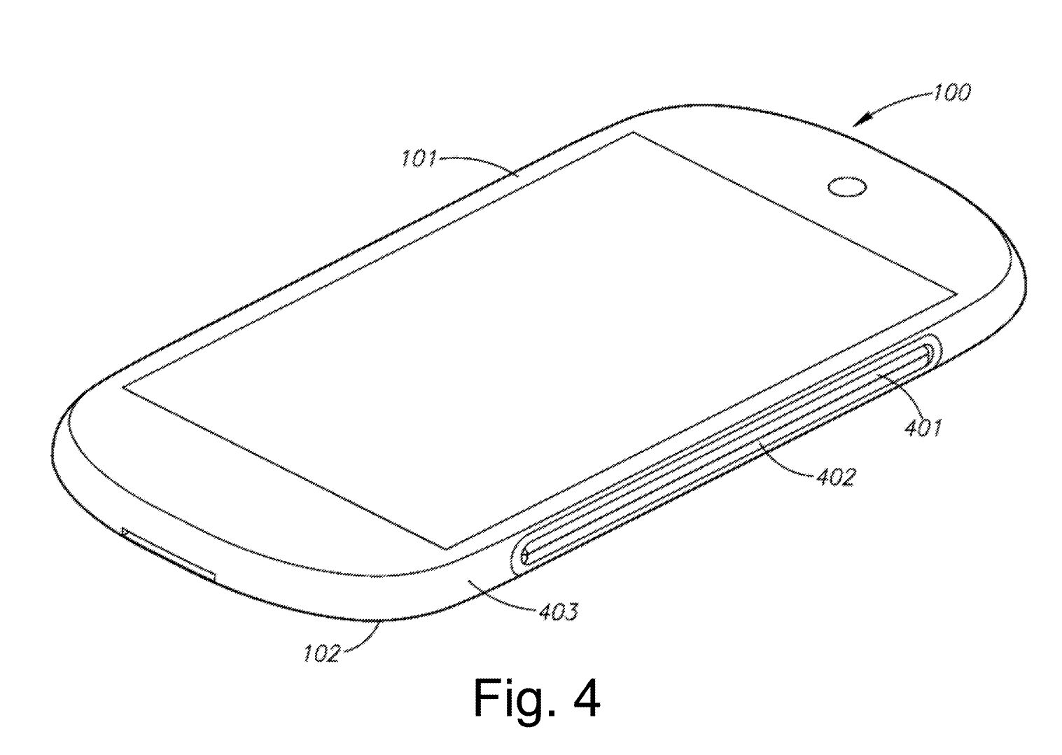

As an example of a different touch area configuration, FIG. 4 shows an embodiment of handheld device 100 having two straight or linear touch-sensitive areas or bands 401 and 402, positioned adjacently along the vertical length of the right side or edge 403 of handheld device 100. Front touch band 401 is positioned on the right edge 403, toward or adjacent front surface 101. Rear touch band 402 is positioned on the right edge 403, toward or adjacent rear surface 102.

Tactile delineation between touch bands 401 and 402 can be provided by a ridge or valley between the bands. Alternatively, the bands can have different elevations relative to right side surface 403.

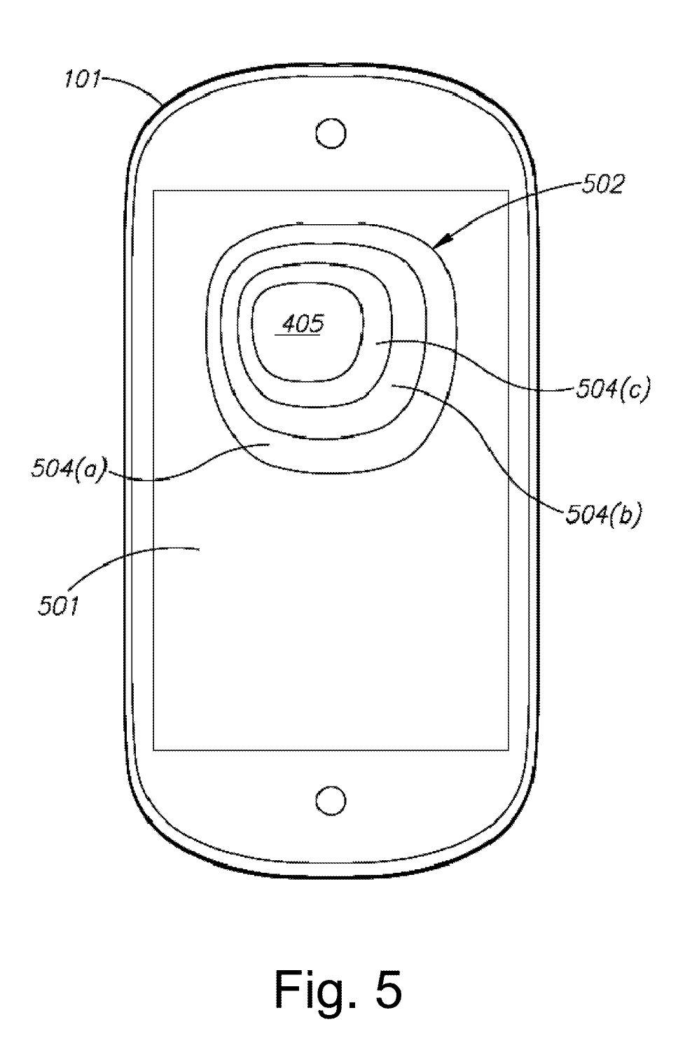

FIG. 5 is a front view of handheld device 100 (in this embodiment, a cellular phone), showing one possible configuration of front surface 101. In this embodiment, there is a front-facing display or display panel 501 in front surface 101. In some embodiments, display panel 501 may be a touch sensitive display panel. Other user interface elements, such as buttons, indicators, speakers, microphones, etc., may also be located on or around front surface 101, although they are not shown in FIG. 5.

Display panel 501 can be used as part of a user interface to operate handheld device 100. It can also be used to display content, such as text, video, pictures, etc.

A graphical menu 502 can be displayed at times on front display 501. Menu 502 has a plurality of graphically- or visually-delineated menu areas or bands 504 corresponding respectively to the tactually-delineated touch sensitive areas 104 on alternate surface 102. In this example, menu areas 504 include an outer band 504(a), a middle band 504(b), and an inner band 504(c). In addition, menu 502 includes a center visual area 505.

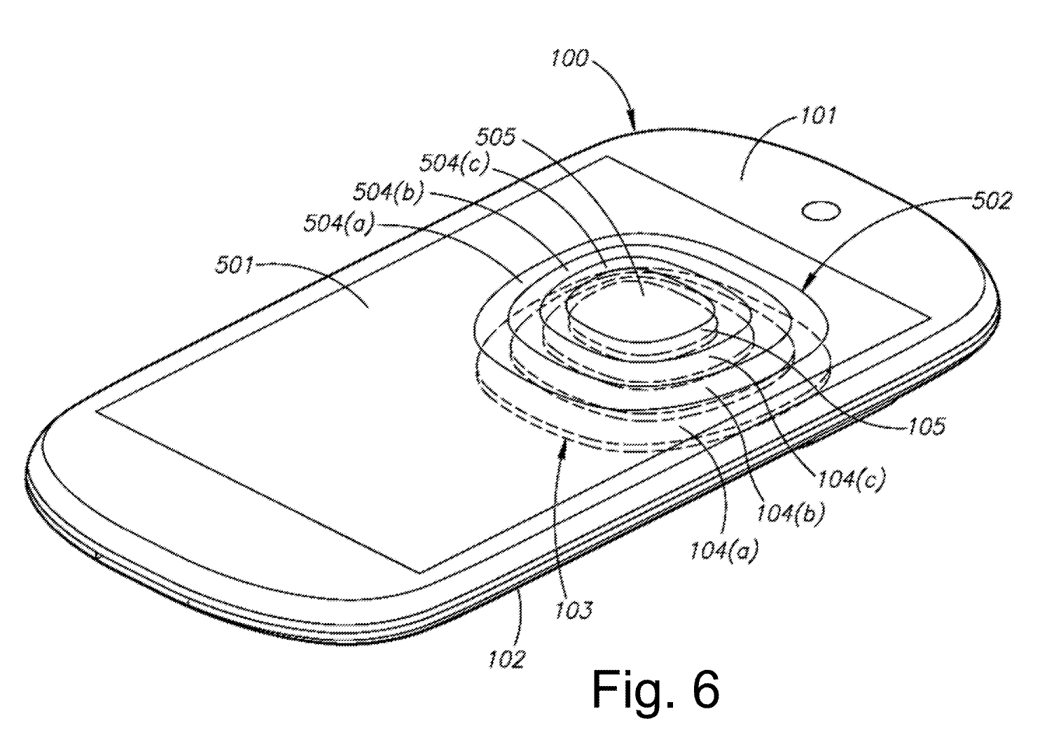

FIG. 6 illustrates relative positions of touch panel 103 and graphical menu 502 in one embodiment. In this embodiment, rear touch panel 103 is positioned opposite and directly behind display panel 501. Bands 504 of graphical menu 502 are shaped and sized the same as their corresponding touch-panel bands 104, and are positioned at the corresponding or same lateral coordinates along front surface 101 and alternate surface 102. Thus, outer touch band 104(a) has generally the same size, shape, and lateral position as outer menu band 504(a); middle touch band 104(b) has generally the same size, shape, and lateral position as middle menu band 504(b); inner touch band 104(c) has generally the same size, shape, and lateral position as outer menu band 504(c); and center area 105 of touch panel 103 has generally the same size, shape, and lateral position as center area 505 of front display panel 501.

Generally, graphical menu 502 faces the user, and touch panel 103 faces away from the user. However, display panel 501 and touch panel 103 may or may not be precisely parallel with each other. Although in particular embodiments it may be desirable to position graphical menu 502 so that is directly in front of and aligned with touch panel 103 as illustrated, other arrangements may work well in certain situations. In particular, in some embodiments there may be a lateral and/or angular offset between graphical menu 502 and touch panel 103, such that touch panel 103 is not directly behind menu 502 or is not parallel with the surface of display panel 501. Furthermore, the correspondence in size and shape between the menu bands and the touch bands may not be exact in all embodiments. Thus, the bands and center area of touch panel 103 and menu 502 may differ from one another, but will be similar enough that when a user interacts with touch panel 103, the user perceives it to have a one-to-one positional correspondence with the elements of menu 502.

In operation, as will be described in more detail below, menu items are displayed in menu bands 504. Each displayed menu item is located at a particular point on a menu band 504, and therefore corresponds to a similar point on corresponding touch band 104 of touch panel 103. A particular menu band 504 can be selected or activated by touching its corresponding touch band. A particular menu item can be selected or activated by touching the corresponding position or location on the corresponding touch band 104.

Generally, touching any particular location on touchpad 103 can be considered similar to touching or clicking on the corresponding location on graphical menu 502. If a user desires to select a menu item or some other graphical object positioned at a particular point on menu 502, for example, he or she presses the corresponding point or location on touch panel 103. The tactual delineations between bands of touch panel 103 help the user identify and move between graphical menu bands to locate particular menu item groups.

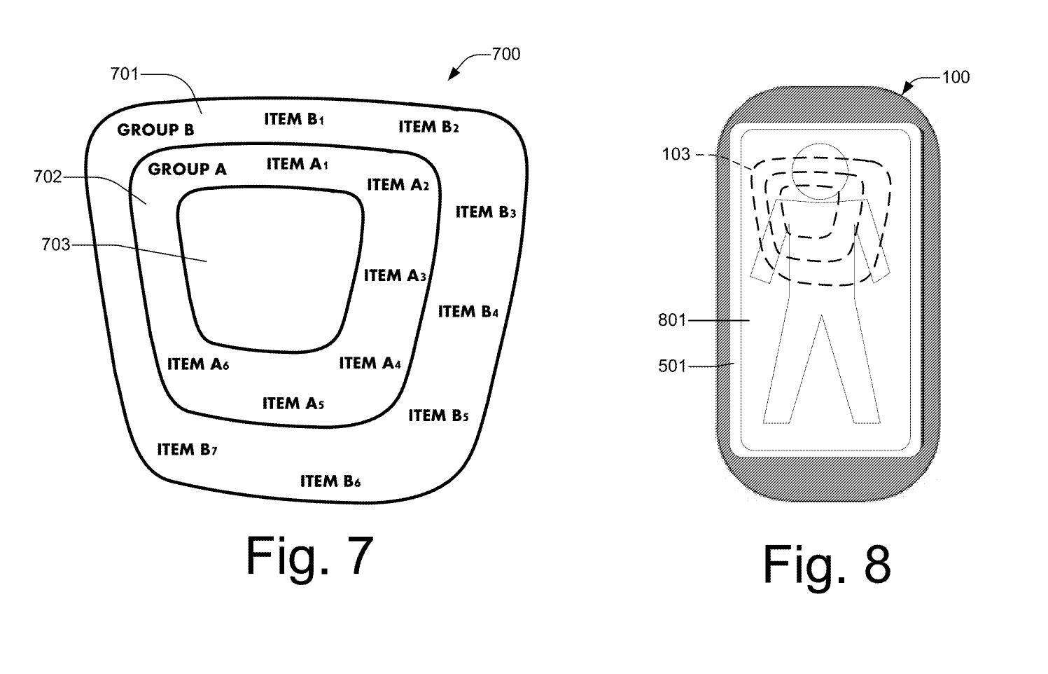

FIG. 7 shows details of how such a menu 502 might be structured. FIG. 7 shows a menu structure 700 as an example of both menu 502 and its corresponding touch panel 103. This example uses two selection bands: an outer band 701 and an inner band 702, both of which surround a center area 703. Outer band 701 corresponds to an outer displayed menu band and a correspondingly positioned outer touch band on alternate surface 102. Inner band 702 corresponds to a displayed inner menu band and a correspondingly positioned inner touch band on alternate surface 102. Center area 703 corresponds to an area within the displayed menu as well as a correspondingly positioned touch sensitive area on touch panel 103. Thus, it is assumed in this example that touch panel 103 has two touch bands, corresponding to the two touch bands shown in FIG. 7.

Generally, each of the menu bands 701 and 702 contains a group of related menu items. Each menu item may be represented by text or a graphical element, object, or icon. In this example, the items are represented by text. Inner menu band 702 contains menu items labeled “ITEM A1”, “ITEM A2”, “ITEM A3”, “ITEM A4”, “ITEM A5” and “ITEM A6”. Outer menu band 701 contains menu items labeled “ITEM B1”, “ITEM B2”, “ITEM B3”, “ITEM B4”, “ITEM B5”, “ITEM B6”, and “ITEM B7”.

Each menu band 701 and 702 may also have a band heading or title, indicating the category or type of menu items contained within the band. In this example, inner menu band 702 has a heading “GROUP A”, and outer menu band 701 has a heading “GROUP B”.

Generally, individual menu items correspond to actions, and selecting a menu item initiates the corresponding action. Thus, hand-held device 100 is configured to initiate actions associated respectively with the menu items in response to their selection.

FIG. 7 illustrates one of many variations of band shapes that might be utilized when implementing both menu 502 and its corresponding touch panel 103. In this non-symmetrical variation, the bands have larger widths toward their right-hand and lower sides. This configuration is intended to work well when the device is held in the left hand of a user, who uses his or her left index finger to interact with touch panel 103. This leaves the right hand free to interact with display panel 501 on front surface 101.

In a configuration such as this, touch panel 103 may be symmetrical, with bands that are the same width on their left and right sides. Menu 502 might be non-symmetrical, similar to menu structure 700. The non-symmetry of menu 502 might allow menu items labels and icons to easily fit within its right-hand side. However, the slight differences between the shapes of the touch bands and the corresponding menu bands will likely be nearly imperceptible to a user, or at least easily ignored. This arrangement allows menu 502 to be displayed using either a right-hand or left-hand orientation, depending on preferences of a user, while using the same touch panel 103.

User interaction can be implemented in different ways. For purposes of discussion, interaction with touch panel 103 will be described with reference to bands and locations of menu structure 700. Thus, “touching” or “tapping” ITEM A1 is understood to mean that the user touches the corresponding location on touch panel 103.

Menu structure 700 can be sensitive to the context that is otherwise presented by handheld device 100. In other words, the particular menu items found on menu 700 may vary depending on the activity that is being performed on handheld device 100. Furthermore, different bands of menu 700 can have menu items that vary depending on a previous selection within a different band. Specific examples will be described below.

In certain embodiments, menu 700 may be activated or initiated by touching center touch area 105 of touch panel 103. In response, handheld device displays menu 700. Alternatively, menu 700 might be activated by touching any portion of touch panel 103, or by some other means such as by interaction with front-surface elements of handheld device 100.

Upon initially displaying menu structure 700, individual menu items may or may not be displayed. For example, upon initial display, each menu band may only indicate its group heading or title, and the individual menu items may be hidden.

After activating menu structure 700 by touching center area 703, the user may touch one of the touch bands to activate or reveal the menu items within that touch band. For example, the user may touch inner band 702, which causes device 100 to activate that band and to display or reveal its individual menu items. In addition, activating a particular band might result in that band being highlighted in some manner, such as by an animation, bold text, or distinguishing shades or colors. Activation or selection of a band might also be indicated by enlarging that band on displayed menu 700 in relation to other, non-activated bands.

Another band might be activated by touching it, or by selecting an item from a first band. For example, outer band 701 may contain items that depend on a previous selection made from the items of inner band 702. Thus, touching or selecting an item within inner band 702 may activate outer band 701, and outer band 701 might in this scenario contain items or commands related to the menu item selected from inner band 702.

Selection of a band or menu item may be made by touching and releasing the corresponding location on touch panel 103. Alternatively, selection may be made by touching at one location, sliding to another location, and releasing. For example, menu structure 700 may be implemented such that touching center area 703 opens menu structure 700, and sliding to inner band 702 allows the user to move to a menu item on inner band 702. Releasing when over a particular menu item might select or activate that menu item.

Selection within menu structure 700 or within a band of menu structure 700 may be accompanied by a highlight indicating the location of the user's finger at any time within the menu structure. For example, touching in a location on touch panel 103 in a location corresponding to ITEM A1 may cause ITEM A1 to become bold or otherwise highlighted. Furthermore, any area that is currently being touched can be made to glow on display panel 501, or some similar visual mechanism can be used to indicate finger placement and movement on menu structure 700. Thus, a user might touch a menu band, move his or her finger along the menu band until the desired menu item is highlighted, and then release his or her touch, thereby activating the menu item that was highlighted upon the touch release.

### Usage Scenarios

The user interface arrangement described above can be used in a variety of ways. The following examples assume the use of front-facing display panel 501 and rear-facing touch panel 103. For purposes of example and illustration, touch panel 103 will not be explicitly shown in the figures accompanying this discussion. It is assumed that in the examples described, touch panel 103 lies directly behind the illustrated graphical menus, and that the touch bands of the touch panel have shapes and sizes that correspond at least roughly with the menu bands of the displayed graphical menus. User interactions with the touch panel will be described with reference to corresponding points on the displayed graphical menus.

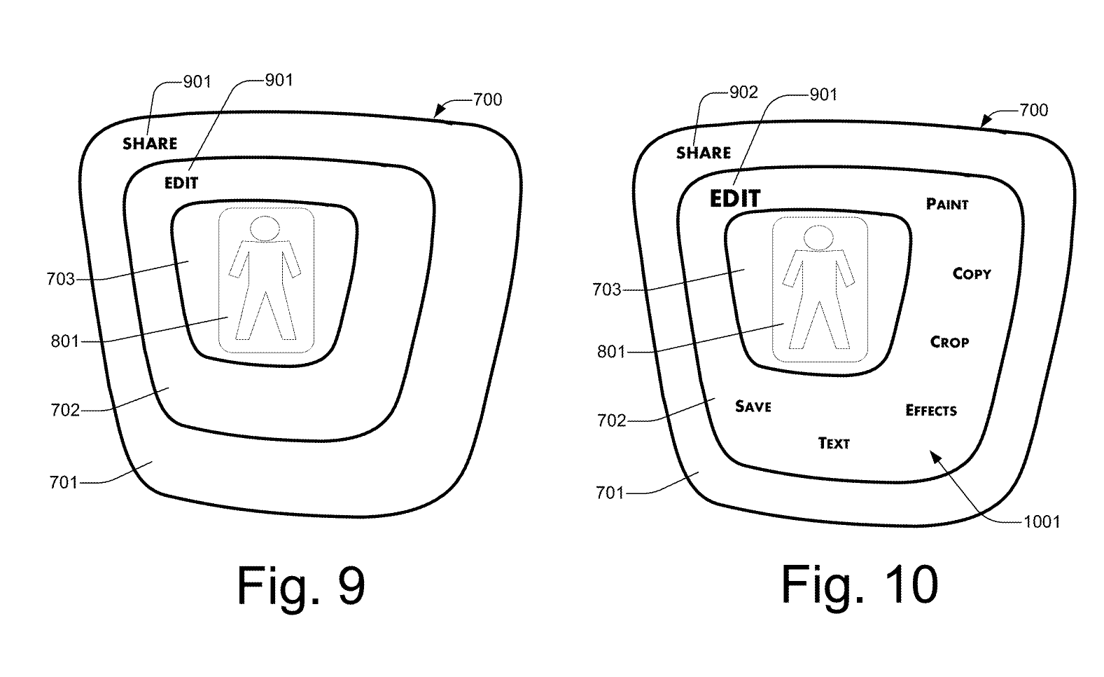

FIGS. 8-11 illustrate how the elements and techniques described above might be used to edit and share a picture that is stored on a handheld device such as a cellular telecommunications device. In FIG. 8, handheld device 100 is displaying a photograph 801 on its display surface 501. Touch panel 103 is represented in dashed lines to indicate its location relative to display panel 501. A menu is not displayed in FIG. 8.

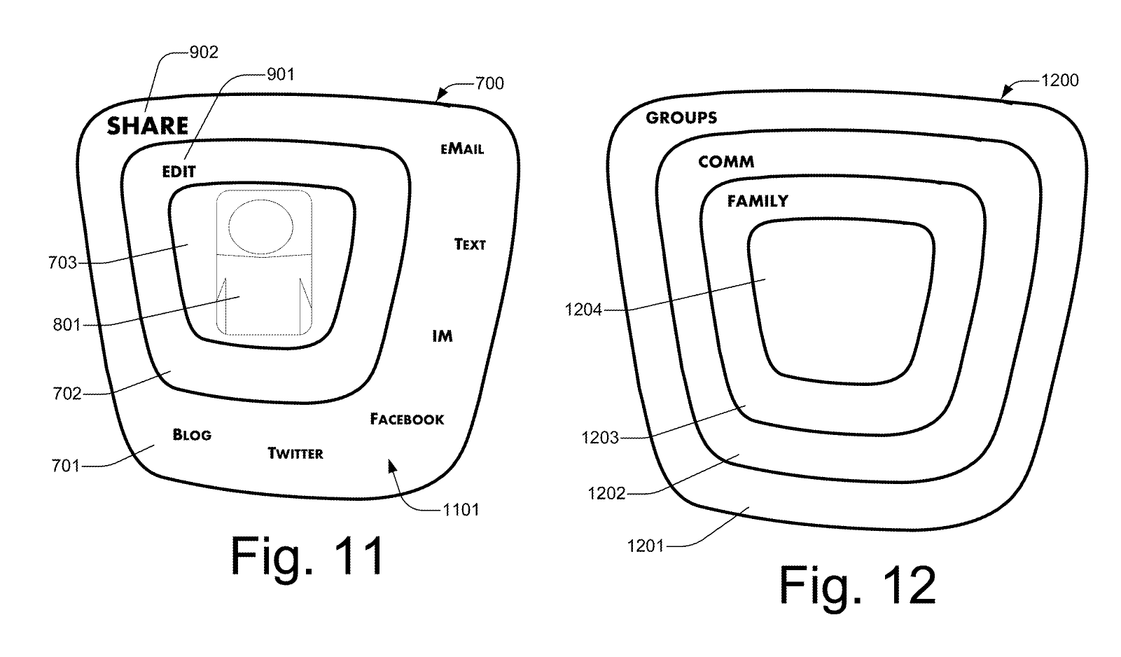

FIG. 9 shows a menu 901 that is displayed on display panel 501 in response to a user touching center area 105 of touch panel 103. This menu is configured to allow a user to perform various operations with respect to the displayed picture 801. The object of these operations, picture 801, is displayed or represented within center area 703. Inner band 702 is configured to correspond to various editing operations that can be performed on picture 801, and has a band heading 901 that reads “EDIT”. Outer band 701 is configured to correspond to various communications options that can be performed in conjunction with picture 801, and has a band heading 902 that reads “SHARE”. A user can touch anywhere in inner band 702 to activate or reveal the menu items of that band. A user can touch anywhere in outer band 701 to activate or reveal the menu items of that band.

FIG. 10 shows the result of a user touching inner band 702. In response to touching a band, it is activated or highlighted. In this example, an activated band is enlarged and its menu items are revealed. Menu items 1001 of inner band 702 comprise “Paint”, “Copy”, “Crop”, “Effects”, “Text”, and “Save”. While still touching inner band 702, the user can move his or her finger around inner band 702 until it is positioned corresponding to a desired menu item. In some embodiments, the location at which the user is touching the band will be highlighted or somehow indicated on display 501 so that finger movement can be visually confirmed. When the finger is at the desired menu item, the user released the finger touch and the menu item is selected or activated.

Suppose, for example, that the user wants to crop the displayed picture 801. The user first touches and releases center area 703 to activate menu 700. The user then touches inner band 702, which reveals menu items 901 relating to editing actions. The user moves his or her finger until touching the menu item “Crop”, and releases. This causes device 100 to display an on-screen tool for cropping picture 801. Although this tool is not illustrated, picture 801 may be again displayed in full size on front display panel 501, as in FIG. 8, and a moveable rectangle may be shown for the user to position in the desired cropping location. The user may drag the displayed rectangle by pressing and dragging on display panel 501 to achieve the desired positioning of the rectangle, and the desired cropping of picture 801.

FIG. 11 shows a subsequent operation that may be performed on the cropped picture 801. After the cropping operation described above, the cropped picture 801 is displayed in center area 703 as the object of a proposed action. Menu 700 may reappear after the cropping operation, or may be reactivated by the user again touching center area 703.

In the example of FIG. 11, the user has touched the outer band 701 to reveal the menu items 1101 of that band, which relate to different communications options that are available with regard to the targeted picture. These options include “Email”, “Text”, “IM”, “Facebook”, “Twitter”, and “Blog”. These menu items correspond to actions that device 100 or an application program within device 100 will initiate upon selection of the menu items. Notice that in this example, as with FIG. 10, the activated menu band is enlarged to indicate that it is active. Enlarging the active menu band also allows its menu items to occupy more screen space and therefore make them more visible to the user.

FIGS. 12-15 illustrate how the elements and techniques described might be used to select and interact with different contacts, using a menu structure 1200 that is displayed on handheld device 100. Example menu 1200 uses three levels of menu bands and corresponding touch bands: an outer band 1201, a middle band 1202, and an inner band 1203. These bands surround a center area 1204.

FIG. 13 shows the menu items 1301 revealed upon activating inner band 1203. In this example, inner band 1203 contains menu items corresponding to contacts that the user has designated as belonging to a particular group. It contains a group heading or label 1302, which in this example reads “FAMILY”, indicating that the contacts within this band are part of the “FAMILY” contact group. In this example, the menu items include “Mom”, “Dad”, “Aric”, “Janelle”, “Grandma”, and “Jim”. A user can touch or select any one of these menu items to select the corresponding contact.

FIG. 14 shows menu items 1401 that are revealed upon activating middle band 1202. These menu items relate to activities that can be performed with respect to a contact that has been selected from inner band 1203. Middle band 1202 has a group heading or label 1402, which in this example reads “COMM”, indicating that the band contains communications options.

In this example, “Jim” has been previously selected from inner band 1203 and is displayed in center area 1204 as the object of any selected operations. The menu items and corresponding operations include “eMail”, “Text”, “Call”, “Chat”, and “Twitter”. The available menu items might vary depending on the information available for the selected contact. For example, some contacts might only include a telephone number, and communications options might therefore be limited to texting and calling. Other contacts might include other information such as Chat IDs, and a “Chat” activity might therefore be available for these contacts. Thus, the menu items available in this band are sensitive to the menu context selected in previous interactions with menu 1200.

FIG. 15 shows menu items 1501 that are revealed upon activating outer band 1201. Outer band 1201 contains menu items corresponding to different contact groups that a user has defined, and contains a group heading or title 1502 that reads “GROUPS”. In this example, these contact groups include “Family”, “Office”, “Friends”, and “Favorites”. Selecting one of these groups changes the context of menu 1200. In particular, it changes the contact group that is shown within inner band 1203. After selecting “Office” from outer band 1201, for example, the label 1302 of inner band 1203 will change to “OFFICE”, and the listed menu items 1301 within inner band 1203 will change to those that the user has included in the “User” group.

The above usage scenarios are only examples, and the user described interaction techniques might be useful in many different situations. As another example, the described menu structure might be used as an application launcher, with different types of applications being organized within different menu bands. End-users may be given the ability to organize applications within menu bands in accordance with personal preferences.

The described menu structure might also be used as a general context menu, presenting operations such as copy, paste, delete, add bookmark, refresh, etc., depending on operations that might be appropriate at a particular time when the menu structure is opened. Again, different types of operations might be presented in different menu bands, such as “edit” operations in an inner band and “sharing” operations in an outward band.

Furthermore, support for the menu structure can be provided through an application programming interface (API) and corresponding software development kit (SDK) to allow the menu functionality to be used and customized by various application programs. In addition, the operating system of the handheld device can expose APIs allowing application programs to register certain activities and actions that might be performed with respect to certain types of objects, or in certain contexts. Registering in this manner would result in the indicated activities or actions being included in the contextual menus described above.

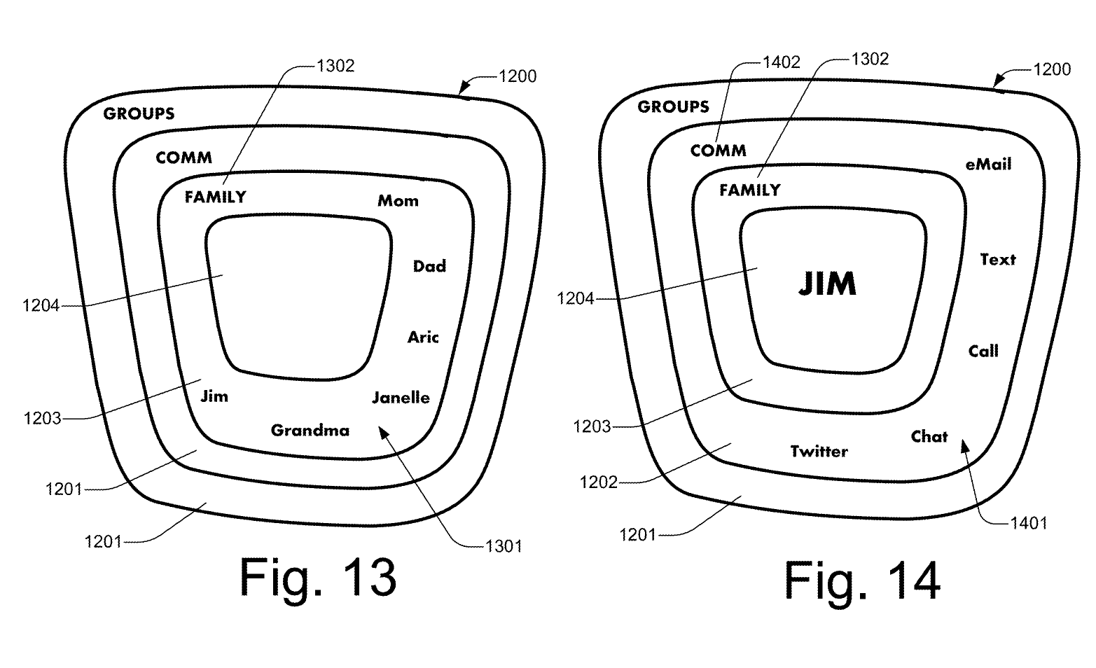

FIG. 16 illustrates the above user interface techniques in simplified flowchart form. An action 1601 comprises displaying a menu on a front-facing display of a handheld device. As described above, the menu may have visually-delineated menu areas or bands corresponding in shape and position to the nested or hierarchical touch bands of a rear-facing touch sensor of the handheld device.

An action 1602 comprises displaying menu items in the menu bands. As already described, each menu item corresponds to a position on the rear-facing touch sensor of the handheld device.

An action 1603 comprises navigating among the menu bands and menu items in response to rear touch sensor input. Action 1604 comprises selecting a particular one of the menu items in response to the user touching its corresponding position on the rear-facing touch sensor.

Note that in the embodiments described above, having a front-facing touch-sensitive display, some of the user interactions might be performed by touching the display itself at the desired menu location, as an alternative to touching the corresponding location on the rear touch panel. Some embodiments may allow the user to touch either the front displayed menu or the corresponding rear touch panel, at the user's discretion.

### Device Components

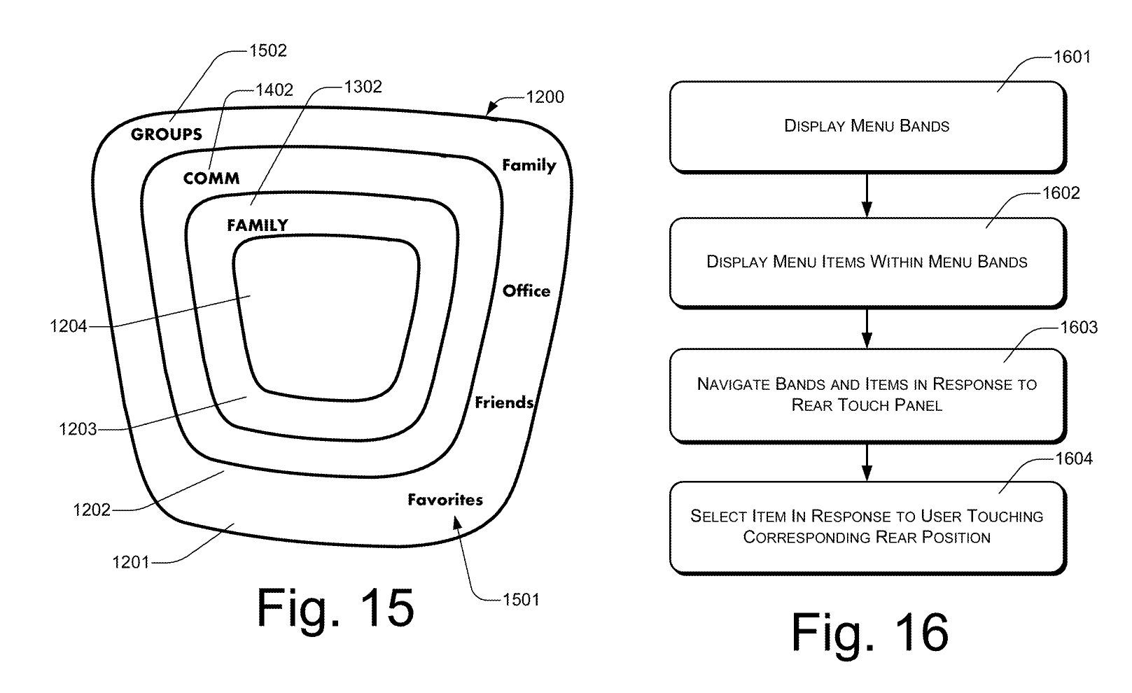

FIG. 17 shows relevant components of an exemplary device 1700 implementing the features described herein.

Device 1700 of FIG. 17 comprises one or more processors 1701 and memory 1702. Memory 1702 is accessible and readable by processors 1701 and can store programs and operational logic for implementing the functionality described herein. Specifically, memory 1702 can contain instructions that are executable by processors 1701 to perform and implement the described functionality.

In some cases, the programs and logic of memory 1702 will be organized as an operating system (OS) 1703 and applications 1704. OS 1703 contains operational logic for basic device operation, while applications 1704 work in conjunction with OS 1703 to implement additional, higher-level functionality. Applications 1704 may in many embodiments be installed by device manufacturers, resellers, retailers, or end-users. In other embodiments, the OS and applications may be built into the device at manufacture. Furthermore, some implementations may be specially programmed with a dedicated program or set of instructions, and may or may not have separate operating system and application layers.

Note that memory 1702 may include internal device memory as well as other memory that may be removable or installable. Internal memory may include different types of machine-readable media, such as electronic memory, flash memory, and/or magnetic memory, and may include both volatile and non-volatile memory. External memory may similarly be of different machine-readable types, including rotatable magnetic media, flash storage media, so-called “memory sticks,” external hard drives, network-accessible storage, etc. Both applications and operating systems may be distributed on such external memory and installed from there. Applications and operating systems may also be installed and/or updated from remote sources that are accessed using wireless means, such as WiFi, cellular telecommunications technology, and so forth.

Some embodiments of device 1700 may have a display 1705 and a touch panel 1706, the characteristics of which are described herein. OS 1703 and/or applications 1704 interact with display 1705 and touch panel 1706 to implement the user interface behaviors and techniques described above. In many embodiments, device 1700 might have an application programming interface (API) 1707 that exposes the functionality of display 1705 and touch panel 1706 to applications through high-level function calls, allowing third-party application to utilize the described functionality without the need for interacting with device components at a low level. API 1707 may include function calls for performing the actions described with reference to FIG. 16, including:
displaying a menu on a front-facing display, the menu having visually-delineated menu bands corresponding in shape and position to the nested touch bands of the rear-facing touch sensor;
displaying menu items in the menu bands, each menu item corresponding to a position on the rear-facing touch sensor; and
selecting a particular one of the menu items in response to the user touching its corresponding position on the rear-facing touch sensor.

Similarly, API 1707 may allow application programs to register certain functions or actions, along with potential objects of those functions or actions, allowing the handheld device to include those functions and activities as menu items in appropriate contexts.

Device 1700 may also include other input/output elements 1708, such as different types of displays, touch-sensitive display panels, controls, buttons, lenses, image capture devices, storage devices, microphones, etc.

Note that various embodiments include programs, devices, and components that are configured or programmed to perform in accordance with the descriptions herein, as well as computer-readable storage media containing programs or instructions for implementing the described functionality. Various different device embodiments, utilizing different types of operational logic and input output elements, will be described below. The architecture shown in FIG. 17 is an example illustrating basic operational concepts, and that the various described embodiments might be implemented in many different ways.

### Additional Usage Scenarios

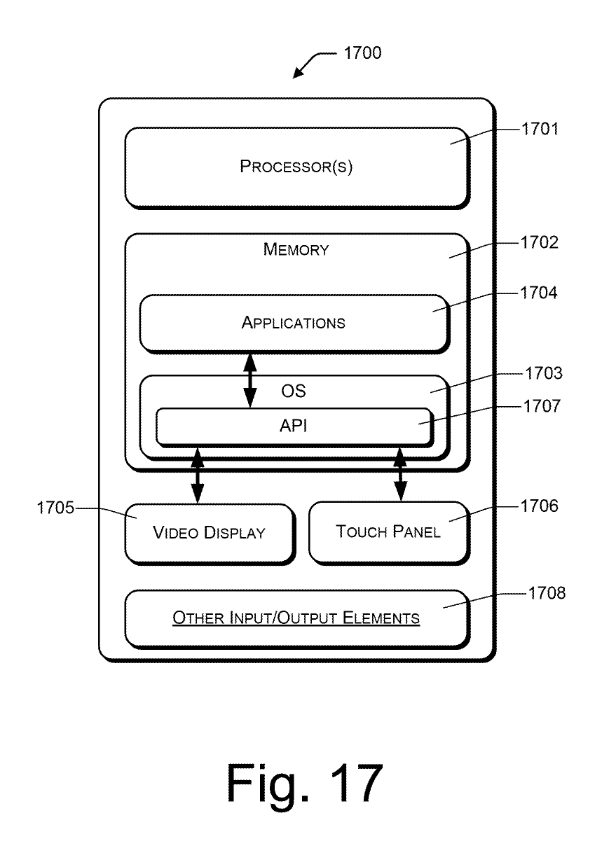

FIG. 18 shows an embodiment in which a multi-region or hierarchical touchpad is used in conjunction with a conventional computing device. In this embodiment, the computing device is a personal desktop computer 1800 comprising a keyboard 1801, a display 1802, and a system controller or processor 1803.

Keyboard 1801 has traditional input mechanisms, including keys or buttons 1804 that are operable by a user to enter text on computer 1800. The keyboard may also have a conventional touchpad 1805 that can be used in place of a computer mouse to control an on-screen pointer or cursor. In addition, there is a multi-level or hierarchical touchpad 1806 positioned at the lower left corner of the top surface of keyboard 1801. In this embodiment, touchpad 1806 is positioned apart and independently from display 1802, not directly behind or otherwise aligned with an on-screen menu 1807.

Although illustrated in conjunction with a traditional desktop computer, hierarchical touchpad 1806 can be used with a variety of different types of computing devices, such as laptop computers, netbook computers, tablet computers, mobile devices, gaming devices, cameras, input peripherals, special purpose computing devices, and so forth. Furthermore, a touchpad such as this can be implemented as a stand-alone accessory or integrated with different types of input devices. For example, it might be integrated with a mouse or digitizer pad.

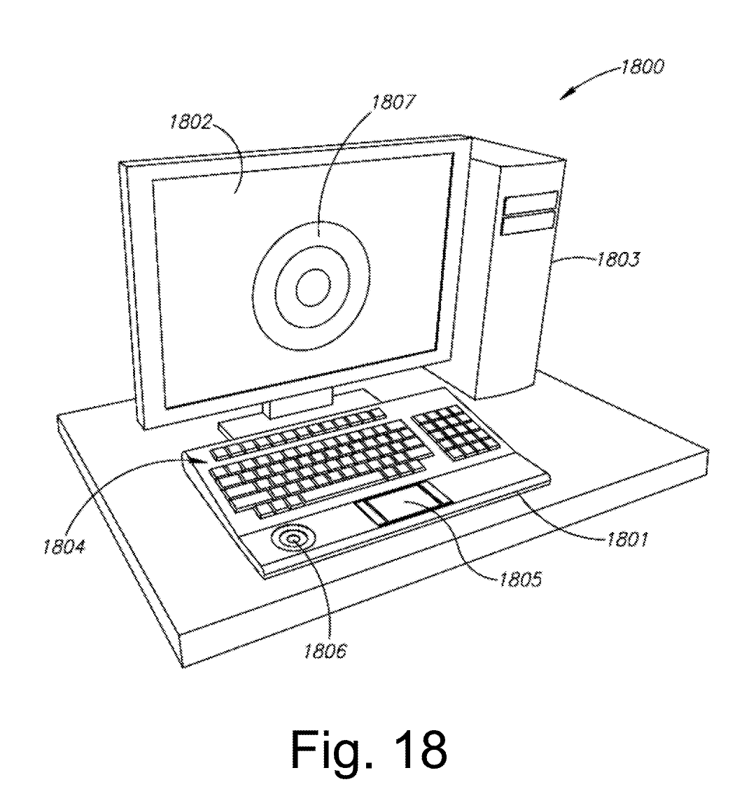

FIG. 19 shows hierarchical touchpad 1806 in more detail. As in some of the previously described embodiments, hierarchical touchpad 1806 has multiple areas that are tactually delineated from each other so that a user can distinguish between the areas by touch. In the described embodiment, the areas comprise a plurality of hierarchically-arranged and tactually delineated touch-sensitive areas or bands. In this embodiment, the touch-sensitive areas or bands are arranged concentrically, surrounding a central touch-sensitive area 1901. An inner or primary touch-sensitive band 1902 has an annular or ring-like shape, and is immediately adjacent central touch-sensitive area 1901. An outer or secondary touch-sensitive band 1903 also has an annular or ring-like shape. Outer touch-sensitive band 1903 surrounds and is immediately adjacent inner touch-sensitive band 1902. Note that the central area 1901 may be omitted in some embodiments, and the inner touch-sensitive band 1902 may comprise a circular area rather than an annular area.

In the described embodiment, each of the touch-sensitive bands 1902 and 1903 has a different elevation or depth relative to a surface 1904 in which it is positioned. There are steps or discontinuous edges 1905 between the different elevations that provide tactile differentiation between bands, allowing a user to reliably locate a particular touch band via tactile feedback with a finger, without visually looking at touchpad 1806.

In this example, each successively inward band or area is stepped down in elevation from surface 1904 or from its outwardly neighboring band. In particular, outer band 1903 is stepped down from surface 1904 and therefore is deeper or has a lower elevation than surface 1904. Inner band 1902 is stepped down from its outwardly neighboring band 1903 and is therefore deeper and has a lower elevation than outer band 1903. Similarly, central area 1901 is stepped down from surrounding inner band 1902 and is therefore deeper and has a lower elevation than inner band 1902.

The progressively and inwardly increasing depths of bands 1902 and 1903 and central area 1901 relative to surface 1904 create a concavity or depression relative to surface 1904. The position and dimensions of touch panel 1806 can be chosen so that a user's finger naturally locates and rests within the concavity, such that it is comfortable to move the finger to different locations around touch panel 1806.

Those of skill in the art will understand that the touch-sensitive bands may each successively extend upward from the bordering larger band. Thus, outer band 1903 may be lower than inner band 1902, which in turn may be lower than central area 1901, thus forming a convex arrangement. In another embodiment, the respective bands may all share the same level, but may be tactually detectable by virtue of a raised border between them. For purposes of simplicity, however, the disclosed embodiment will address only the concave arrangement shown in FIG. 19.

Touchpad 1806 is sensitive to touch, and can detect the particular location at which it is touched or pressed. Thus, it can detect which individual band is touched, and the position or coordinates along the band of the touched location. A user can slide his or her finger radially between bands or around a single band, and touch panel 1806 can detect the movement and absolute placement of the finger as it moves along or over the bands. Central area 1901 is also sensitive to touch in some embodiments.

Touchpad 1806 can be implemented using capacitive, resistive, or pressure sensing technology, or using other technologies that can detect a user's finger placement. Touchpad 1806 may also integrate additional sensors, such as sensors that detect the pressing or depression of central area 1901 or other areas of touchpad 1806. In addition to being sensitive to touching with a finger, the touch-sensitive bands can also be sensitive to touching by a stylus or other object.

Different embodiment may utilize different numbers of bands, and a single band or three bands may be used in different embodiments. Furthermore, the bands may be shaped and positioned differently than illustrated here.

In operation, touchpad 1806 can be used with an on-screen menu having a graphical appearance that is similar to that of the touchpad itself Referring back to FIG. 18, an example of such an on-screen menu 1807 is shown on display 1802.

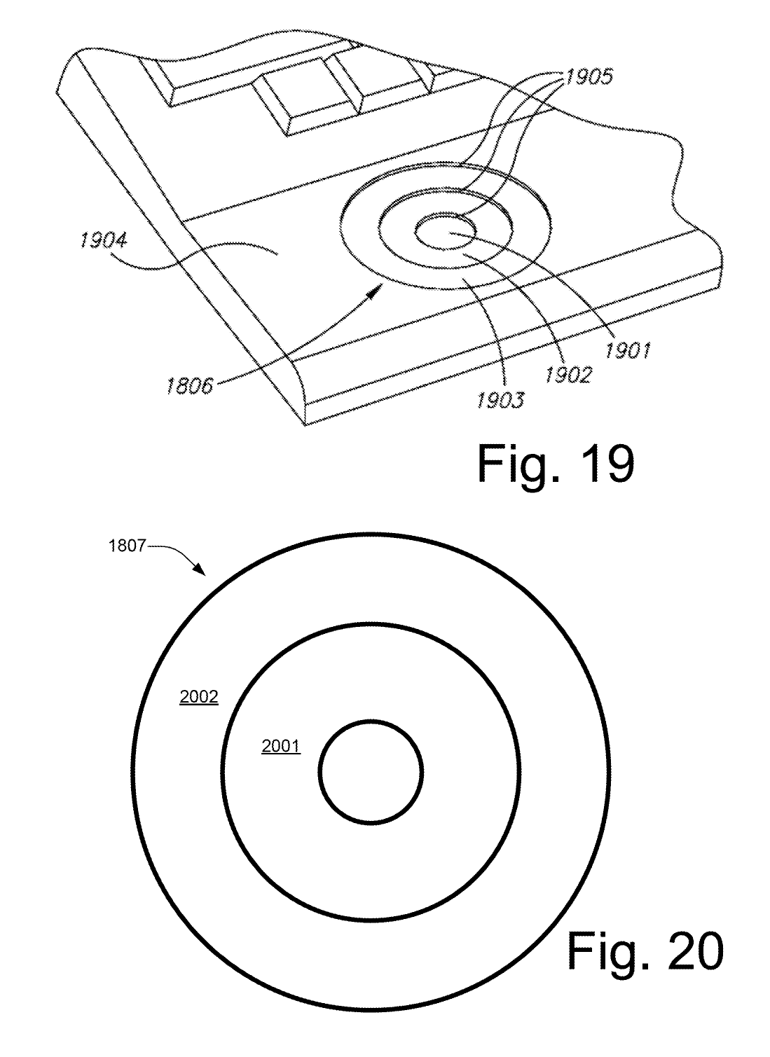

FIG. 20 shows on-screen menu 1807 in more detail. On-screen menu 1807 comprises a first-level menu 2001 and a second-level menu 2002. First-level menu 2001 corresponds to inner touch-sensitive band 1902 and has a shape similar to that of inner touch-sensitive band 1902. Second-level menu 2002 corresponds to outer touch-sensitive band 1903 and has a shape similar to that of outer touch-sensitive band 1903. First-level menu 2001 and second-level menu 2002 are also arranged relative to each other similar to the arrangement of the bands of touchpad 1806, with second-level menu 2002 surrounding and immediately adjacent first-level menu 2001. Each of menus 2001 and 2002 comprises an annular or ring-shaped area within which menu items or choices can be displayed.

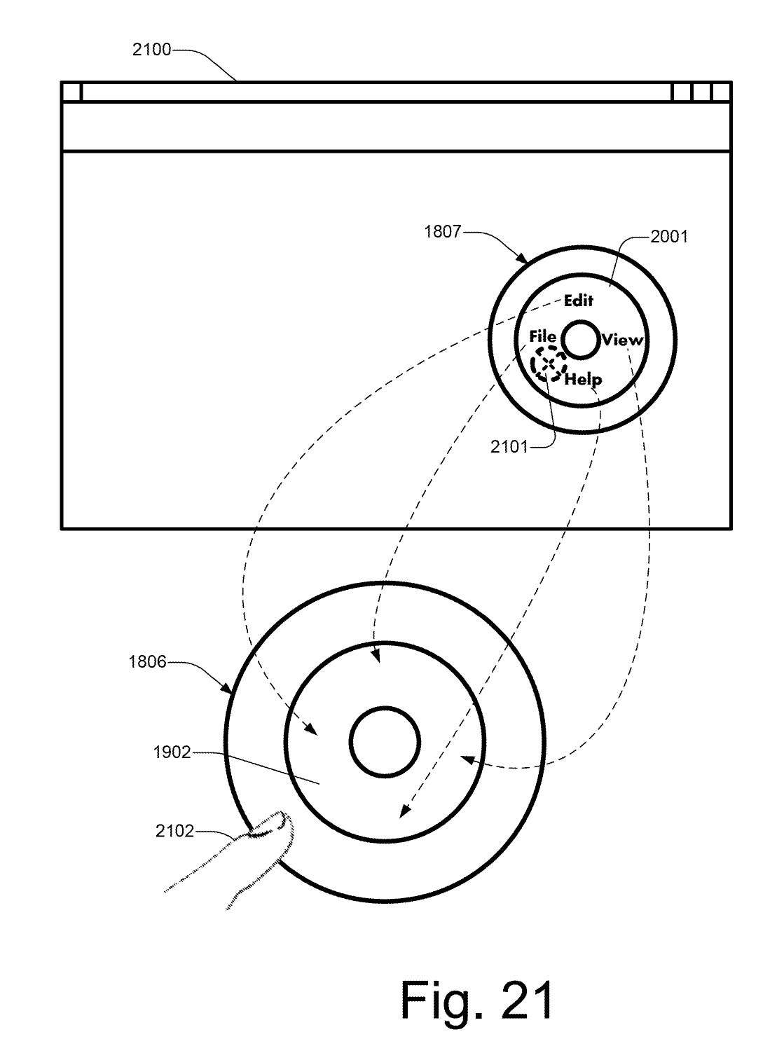

FIG. 21 illustrates a usage embodiment in which there is a one-to-one correspondence between positions of inner touch-sensitive band 1902 and positions of first-level menu 2001. FIG. 21 shows a graphical window or pane 2100 upon which on-screen menu 1807 is displayed. Within menu 1807, first-level menu 2001 is shown as having four menu choices: File, Edit, View, and Help. These choices are distributed around first-level menu 2001 at approximately equal intervals, at the left, top, right, and bottom of first-level menu 2001, respectively.

Dashed arrows indicate, for each of these choices, corresponding locations on inner touch-sensitive band 1902 of touchpad 1806. Generally, the position of a particular menu choice on inner touch-sensitive band 1902 is assumed to be the same as the choice's position on first-level menu 2001. Thus, the “File” choice is displayed at the left of first-level menu 2001, and is assumed to also be located at the left of inner touch-sensitive band 1902. Touching the left of first-level menu is equivalent to selecting or “touching” the “File” menu item. The “Edit” choice is displayed at the top of first-level menu 2001, and is assumed to also be located at the top of inner touch-sensitive band 1902. Touching the top of first-level menu is equivalent to selecting or “touching” the “Edit” menu item. Similarly, the “View” and “Help” choices may be selected by touching their corresponding locations on touchpad 1806.

A cursor or pointer 2101 can be used in some embodiments to indicate on on-screen menu 1807 the current position of a finger on touchpad 1806. The cursor or pointer can be a graphical arrow, dot, highlight, or other type of graphical delineation. In FIG. 21, a finger 2102 is shown touching a point on touch-sensitive band 1902, and the corresponding location of on-screen menu 1807 is indicated by circular cursor 2101. Cursor 2101 provides graphical feedback to the user as the user moves his or her finger to various locations around touch-sensitive bands 1902 and 1903.

In operation, touching touchpad 1806 may cause menu 1807 to appear on window 2100, along with cursor 2101 that indicates where the touch is occurring. As the finger moves along touchpad 1806, cursor 2101 follows its movement in the corresponding areas of menu 1807. The user may visually watch cursor 2101 to verify finger placement, and to guide cursor 2101 over a desired menu choice. For example, the user may use their finger to guide cursor 2101 over the “Edit” choice of first-level menu 2001. Releasing or removing the touch contact with touchpad 1806, while the cursor is over a particular menu choice, results in the selection of that menu choice.

FIG. 22 illustrates the result of selecting the “Edit” choice from first-level menu 2001. In response to the selected first-level choice, second-level menu 2002 is displayed with second-level choices that depend on the selected first-level choice. In this example, the second-level choices comprise “Undo”, “Copy”, “Cut”, and “Paste”. These choices are distributed around second-level menu 2002 at approximately equal intervals, at the left, top, right, and bottom of second-level menu 2002, respectively.

Dashed arrows indicate, for each of these choices, corresponding locations on outer touch-sensitive band 1903 of touchpad 1806. Generally, the position of a particular menu choice on outer touch-sensitive band 1903 is assumed to be the same as the choice's position on second-level menu 2002. Thus, the “Undo” choice is displayed at the left of first-level menu 2002, and is assumed to also be located at the left of outer touch-sensitive band 1903. Touching the left of second-level menu is equivalent to selecting or “touching” the “Undo” menu item. The “Copy” choice is displayed at the top of second-level menu 2002, and is assumed to also be located at the top of outer touch-sensitive band 1903. Touching the top of second-level menu 2002 is equivalent to selecting or “touching” the “Copy” menu item. Similarly, the “Cut” and “Paste” choices may be selected by touching their corresponding locations on touchpad 1806.

Cursor 2101 can be used to indicate the current position of finger 2102 on touchpad 1806 as described above. In this example, finger 2102 is shown touching a point on outer touch-sensitive band 1903, and the corresponding location of on-screen menu 1807 is indicated by cursor 2101. A particular menu choice can be selected by moving the cursor over it and then releasing touchpad 1806.

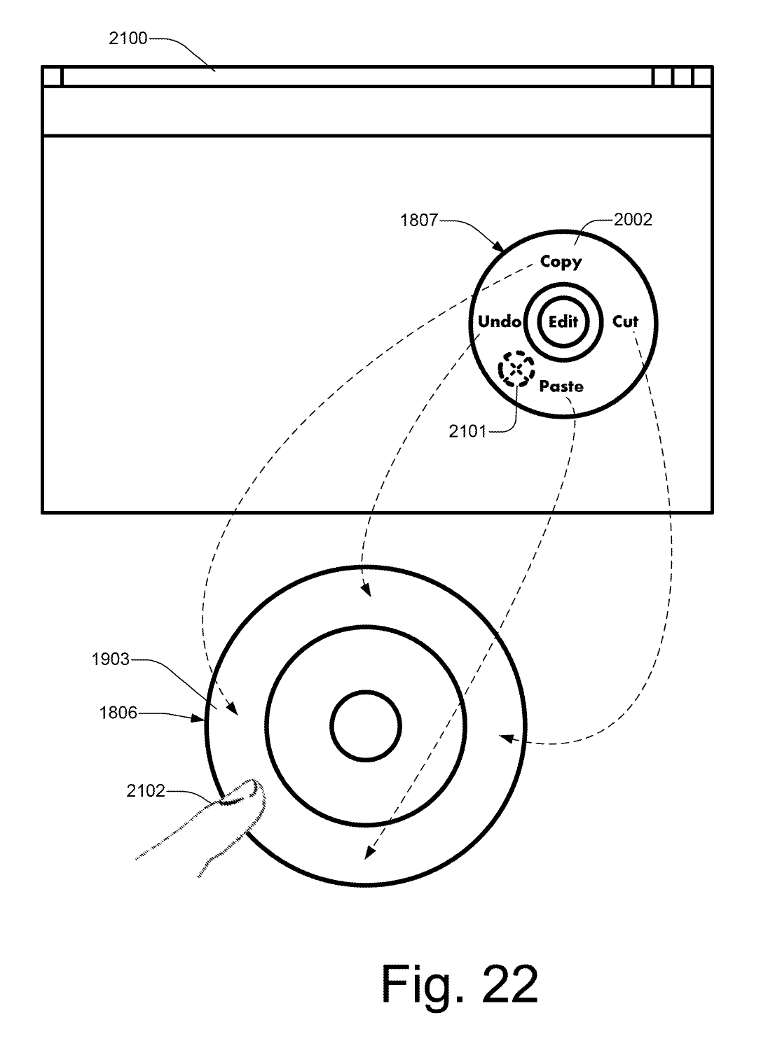

FIG. 23 shows another embodiment, having an on-screen menu that does not correspond in size or shape to the hierarchical touchpad. FIG. 23 shows a graphical window or pane 2300 upon which a first-level menu 2301 is displayed. First-level menu 2001 is shown as having four menu choices: File, Edit, View, and Help. These choices are arranged horizontally and linearly, from left to right, along the top of window 2300.

Dashed arrows indicate, for each of these choices, corresponding locations on inner touch-sensitive band 1902 of touchpad 1806. Generally, the menu choices are arranged on inner touch-sensitive band 1902 in the same sequence as their presentation within first-level menu 2001. Thus, the “File” choice corresponds to the left of inner touch-sensitive band 1902, the “Edit” choice corresponds to the top of inner touch-sensitive band 1902, the “View” choice corresponds to the right of inner touch-sensitive band 1902, and the “Help” choice corresponds to the bottom of inner touch-sensitive band 1902. Thus, touching the left of first-level menu is equivalent to selecting or “touching” the “File” menu item. Touching the top of first-level menu is equivalent to selecting or “touching” the “Edit” menu item. Similarly, the “View” and “Help” choices may be selected by touching their corresponding locations on touchpad 1806.

A cursor or pointer can be used as in previous embodiments to show the current selection. In this example, cursor functionality is provided by underlining any menu choice that the user is currently “touching.” In FIG. 23, the user's finger is assumed to be touching the location on touchpad 1806 corresponding to the “Edit” choice, and the “Edit” choice is therefore underlined.

FIG. 24 shows the result of selecting the “Edit” choice from first-level menu 2301. In response to the selected first-level choice, second-level menu 2401 is displayed with second-level choices that are selectable by touching the secondary touch-sensitive area 1903 of touchpad 1806. In this example, the second-level choices comprise Undo, Copy, Cut, and Paste. These choices are arranged vertically and linearly, beneath the selected first-level menu choice.

Dashed arrows indicate, for each of these choices, corresponding locations on outer touch-sensitive band 1903 of touchpad 1806. Generally, the menu choices are arranged on outer touch-sensitive band 1903 in the same sequence as their presentation within second-level menu 2401. Thus, the “Undo” choice corresponds to the left of outer touch-sensitive band 1903, the “Copy” choice corresponds to the top of outer touch-sensitive band 1903, the “Cut” choice corresponds to the right of outer touch-sensitive band 1903, and the “Paste” choice corresponds to the bottom of outer touch-sensitive band 1903. Thus, touching the left of outer touch-sensitive band 1903 is equivalent to selecting or “touching” the “Undo” menu item. Touching the top of outer touch-sensitive band 1903 is equivalent to selecting or “touching” the “Copy” menu item. Similarly, the “Cut” and “Paste” choices may be selected by touching their corresponding locations on touchpad 1806.

Underlining is again used to indicate a current selection, which in this case is “Cut”. A particular menu choice can be selected by moving the underlining to the appropriate choice and then releasing the touching of touchpad 1806.

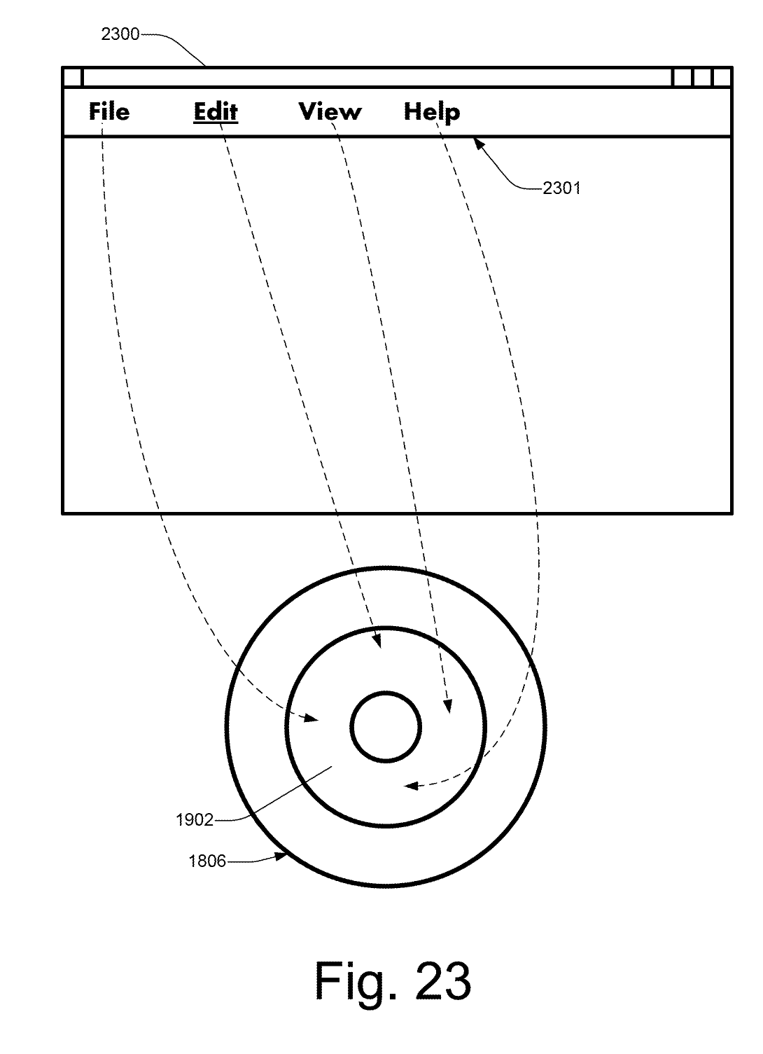

FIG. 25 illustrates yet another usage scenario for a hierarchical touchpad. In this example, inner touch-sensitive band 1902 corresponds to menu choices within a vertical, linear first-level menu 2501. First-level menu 2501 has the menu choices “Start Date”, “Start Time”, “End Date”, and “End Time”, along with corresponding values for those menu choices. The value of a particular menu choice can be selected or changed by selecting the that menu choice from first-level menu 2501. In this case, the “Start Date” choice can be selected by touching the left of inner touch-sensitive band 1902. The “Start Time” choice can be selected by touching the top of inner touch-sensitive band 1903. The “End Date” choice can be selected by touching the right of inner touch-sensitive band 1902. The “End Time” choice can be selected by touching the bottom of inner touch-sensitive band 1902. The correspondence between menu choices and positions on inner touch-sensitive band 1902 are indicated by dashed arrows.

FIG. 26 shows the result of selecting the “End Date” choice. Selecting any choice from the first-level menu 2501 cases a second-level menu 2601 to open, containing menu choices that vary depending on the selected first-level menu choice. In this example, second-level menu 2601 is a scrollable window having second-level menu choices that scroll vertically in response to sweeping outer touch-sensitive band 1903 in a circular motion. A blocked or highlighted line 2602 indicates the current selection: June 16. Sweeping a finger around outer touch-sensitive band 1903 in a clockwise direction scrolls in one direction. Sweeping a finger around outer touch-sensitive band 1903 in a counter-clockwise direction scrolls in the other direction.

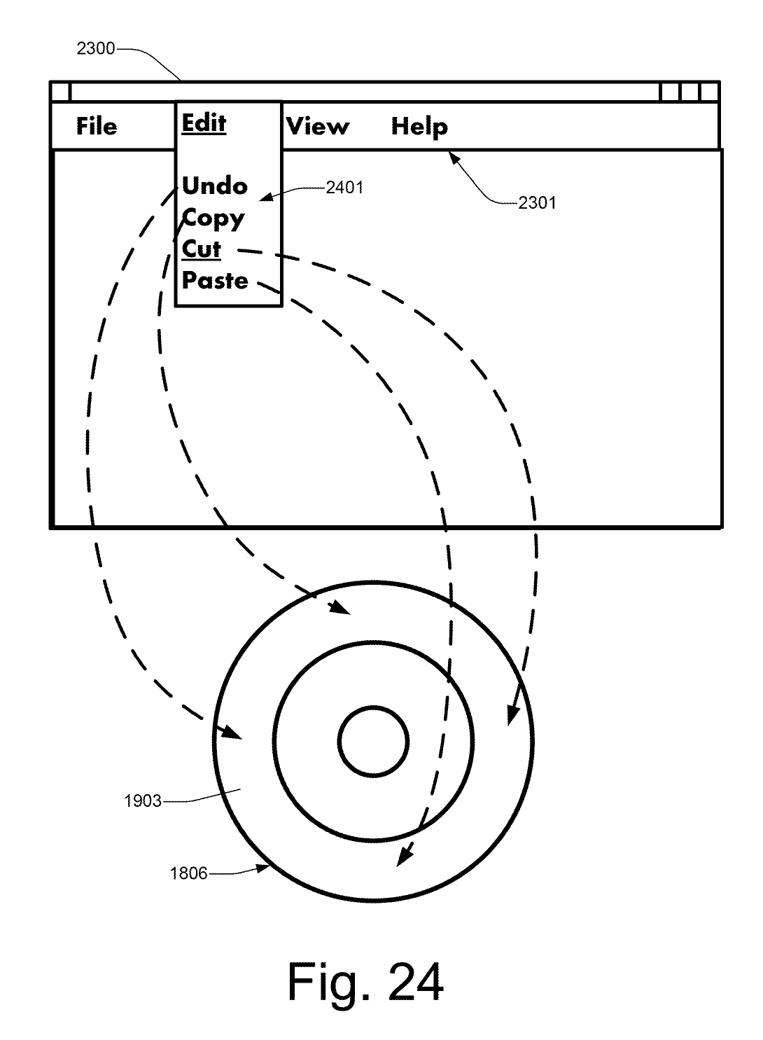

FIG. 27 shows a generalized procedure 2700 to implement the usage scenarios described above, in conjunction with a hierarchical touchpad such as touchpad 1806. Procedure 2700 is described in terms of actions or steps that can be implemented by programs or instruction sequences that are stored in memory and executed by a processor, for example by processor 1701 of FIG. 17 or system controller 1803 of FIG. 18. Other types of operational logic might also be used to implement the described procedure.

An action 2701 comprises displaying first-level choices in a first-level menu, wherein the first-level choices are selectable by touching corresponding locations of a primary band of a hierarchical touchpad such as described above. In some embodiments, the first-level menu has a graphical shape like that of the primary band of the hierarchical touchpad. In other embodiments, the first-level menu may be arranged and shaped differently than the primary band of the hierarchical touchpad.

An action 2702 comprises accepting user selection of a first-level menu choice. A particular choice may be selected by touching the corresponding position on the primary band of the hierarchical touchpad, or by touching and releasing the corresponding position.

An action 2703, performed in response to the user selecting a first-level choice from the first-level menu, comprises displaying second-level menu choices in a second-level menu, wherein the second-level choices are selectable by touching a secondary band of a hierarchical touchpad. In one embodiment, the second-level menu may be displayed initially, upon initial display of the first-level menu. In other embodiments, the second-level menu may be initially hidden, and may be made visible only upon selection of a particular choice from the first-level menu. In either embodiment, the second-level choices of the second-level menu may vary depending on the selected first-level choice. In some embodiments, the second-level menu has a graphical shape like that of the secondary band of the hierarchical touchpad. In other embodiments, the second-level menu may be arranged and shaped differently than the secondary band of the hierarchical touchpad.

An action 2704 comprises accepting user selection of a second-level menu choice. In some embodiments, a particular second-level choice may be selected by touching a corresponding position on the secondary band of the hierarchical touchpad, or by touching and releasing the corresponding position. In some embodiments, touching the secondary band of the hierarchical touchpad in a circular motion may scroll choices through a highlighted cursor, or may scroll a cursor through a list of choices.

Although certain of the above embodiments are described as having two menu levels, other embodiments may have additional menu levels. This is described by actions 2705 and 2706 relating to a third menu level. Actions 2705 and 2706 may be implemented in some embodiments.

Action 2705, performed in response to the user selecting a second-level choice from the second-level menu, comprises displaying third-level menu choices in a third-level menu, wherein the third-level choices are selectable by touching a third band of a hierarchical touchpad. In one embodiment, the third-level menu may be displayed initially, upon initial display of the first-level and second-level menus. In another embodiment, the third-level menu may be initially hidden, and may be made visible only upon selection of a particular choice from the second-level menu. In either embodiment, the third-level choices of the second-level menu may vary depending on the selected second-level choice. In some embodiments, the third-level menu has a graphical shape like that of a third band of the hierarchical touchpad. In other embodiments, the third-level menu may be arranged and shaped differently than the third band of the hierarchical touchpad.

An action 2706 comprises accepting user selection of a third-level menu choice. In some embodiments, a particular third-level choice may be selected by touching a corresponding position on the third band of the hierarchical touchpad, or by touching and releasing the corresponding position. In some embodiments, touching the third band of the hierarchical touchpad in a circular motion may scroll choices through a highlighted cursor, or may scroll a cursor through a list of choices.

As illustrated by the various embodiments, the hierarchical touchpad can be used in various different ways, with various different types of graphical menus that are not limited to the examples shown above.

### Device Examples

Nested, multi-level, or multi-region touchpads such as described above can be incorporated in many different types of devices, including computer input devices like keyboards, computer mice, handheld computers such as PDAs and tablet PCs, computerized devices such as cameras and media players, vehicle controls such as steering wheels, and so forth.

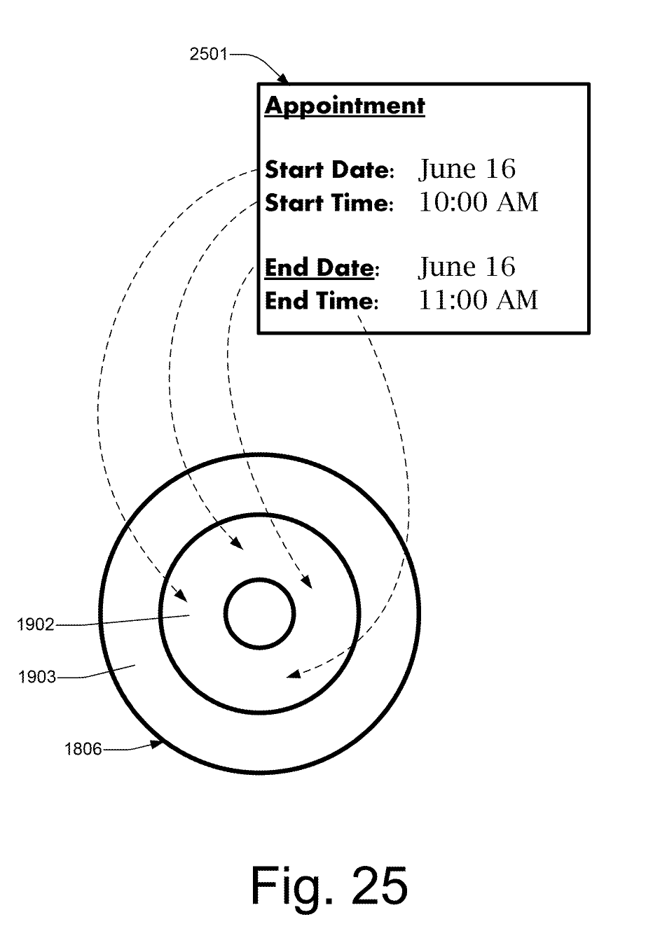

FIG. 28 shows an example of a computer input device for use with a graphical user interface such as the graphical user interface discussed with reference to FIG. 18. A device such as this allows a user to manipulate an element such as a cursor or pointer on the graphical user interface. Devices falling into this category include mice, trackballs, joysticks, gyroscopic controllers, and similar devices. Generally, these devices include at least one control mechanism that a user can move or interact with to control the position of an on-screen cursor, pointer, or tool, or to otherwise control or influence some element of the displayed graphical user interface.

The example of FIG. 28 comprises a computer mouse 2800 having a body 2801 designed to be grasped by the hand of a user to move or slide across a flat surface 2802. In many usage scenarios, movement of the mouse over the flat surface produces a similar movement of a cursor or pointer across the associated graphical user interface. Movement of mouse 2800 is detected by a mechanical roller or other type of sensor in the bottom of mouse 2800. Mouse 2800 can communicate with an associated computer device via an electrical cord or using common wireless communication technologies. Mice or mice-like devices can be implemented in various ways, using various shapes and motion-sensing technologies.

Computer mouse 2800 may have buttons or other controls 2803 that interact with an associated computer device to perform various functions. In addition, computer mouse 2800 has a multi-region touchpad 2804 similar to the touchpad embodiments described above. In this embodiment, multi-region touchpad 2804 is positioned on the top of body 2801, between buttons 2803. It could be alternatively positioned on the side of body 2801, or in other convenient positions.

When used with mouse 2800, multi-region touchpad 2804 can provide an additional way for a user to interact with a computer device. For example, multi-region touchpad 2804 can be used in conjunction with a hierarchical menu, as described above, to perform operations with respect to an object or element indicated by the current position of a cursor. Multi-region touchpad 2804 can also be used to select a current tool and/or tool characteristic, such as selecting a type of paintbrush and a color for the paintbrush, or selecting a line type and width for a line-drawing tool. Rather than scrolling, the locations around the touch bands of multi-region touchpad 2804 can be associated with particular menu choices, so that a user becomes accustomed to the locations of those choices over time. For example, a user may learn that pressing the top of the inner touch band selects the “thin” paintbrush tool, and subsequently touching the left of the outer touch band sets the paintbrush tool to use “red” as its color. In some embodiments, users may be given the ability to configure multi-region touchpad 2804 themselves, so that frequently used commands or menu choices can be made easily available. In some embodiments, one of the touch bands may correspond to a continuous range of selections. For example, the outer touch band may correspond to a continuous gamut of colors as on a color wheel. A combination of three touch bands might be used in this fashion to specify hue, saturation, and brightness, or “red”, “green”, and “blue” components of a color. Many different control schemes might be implemented with touchpad 2804 and mouse 2800, not limited to the examples described here. Furthermore, different applications might implement different control schemes, even when running on the same computer and utilizing the same mouse 2800.

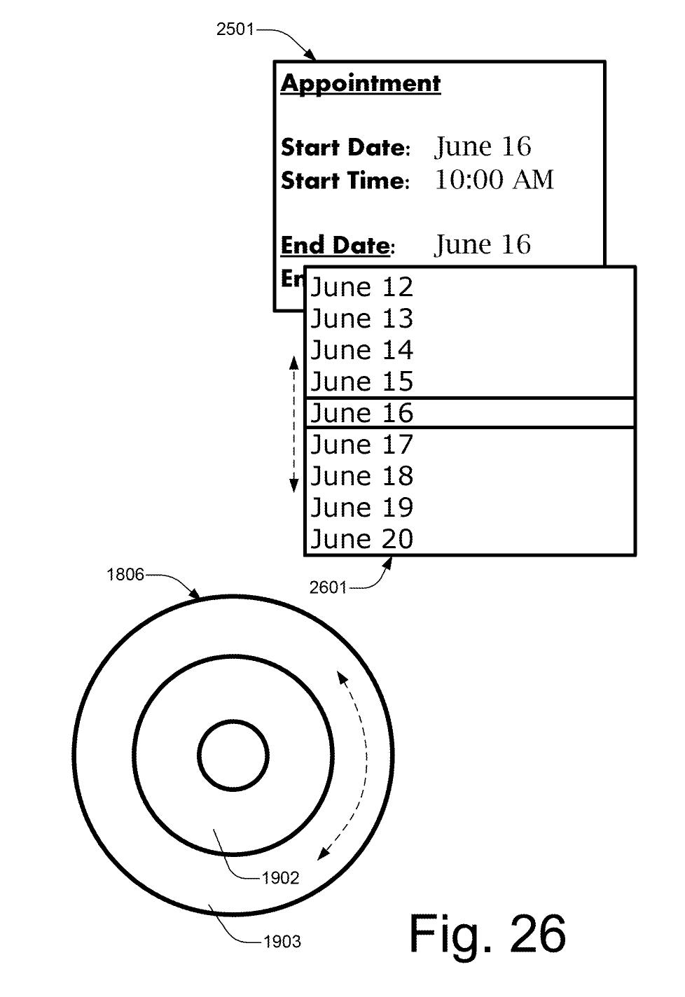

FIG. 29 shows another example of a computer input device. In this case, the computer input device comprises a digitizer pad 2900 and an associated stylus 2901. A digitizer pad is commonly used in conjunction with a graphical user interface to control placement and operation of an on-screen tool, cursor, pointer, or other element. Digitizer pad 2900 has a two-dimensional surface 2902 with an active digitizer configured to sense placement of stylus 2901 when its tip 2903 touches surface 2902. Stylus 2901 is held in the hand of a user like a pencil, and can be moved across surface 2902. In many usage scenarios, movement of the stylus over surface 2902 produces a similar movement of a tool, cursor, or pointer across the associated graphical user interface. Digitizer pad 2900 can communicate with an associated computer device via an electrical cord or using common wireless communication technologies. Digitizer pads and similar devices can be implemented in various ways, using various configurations and stylus detection technologies. Also, some digitizer pads may sense finger placement on surface 2802, in addition or alternatively to stylus placement.

Digitizer pad 2900 has a multi-region touchpad 2904 similar to the touchpad embodiments described above. In this embodiment, multi-region touchpad 2904 is positioned at a corner of digitizer pad 2900. It can be touched by the user's finger or by stylus 2901 to activate menu choices or selections. It could be alternatively positioned in other positions relative to surface 2902, or within surface 2902.

When used with digitizer pad 2900, multi-region touchpad 2904 can provide another way for a user to interact with a computer device. For example, multi-region touchpad 2904 can be used in conjunction with menus, as described above, to perform operations with respect to an object or element indicated by the current position of a cursor. Multi-region touchpad 2904 can also be used to select a current tool and/or tool characteristic. This might be particularly useful in conjunction with a drafting or painting program, in which the stylus is often used as a brush or other drawing tool. In these situations, multi-region touchpad 2904 can be used in a manner similar to a paintwell or inkwell, for choosing current tools and tool characteristics. The tactile delineations of multi-region touchpad 2904 can make it easier for a user to touch the touchpad in a particular location without having to look directly at the touchpad. Furthermore, although touchpad 2900 is shown as being circular, other shapes might be utilized to provide better tactile feedback and to allow easier identification of a “home” or default position.

As described above, the touch bands of multi-region touchpad 2904 can be used in combination and in a hierarchically contextual manner to select and specify tools and characteristics. For example, a tool might be selected by touching a location on an inner touch band. This might result in a dependent set of options being available on an outer touch band. Thus, selecting a “pencil” tool using an inner touch band might result in “pencil width” options being made available through an outer touch band. As already described, currently available menu choices for any active touch band can be indicated via an on-screen menu structure, which in some cases can be shaped similarly to the touch band whose menu choices are being displayed.

As in the previous embodiment, users may be given the ability to configure multi-region touchpad 2904 themselves, so that frequently used commands or menu choices can be made easily available. In addition, one or more of the touch bands may correspond to continuous ranges of selections or choices, rather than to discrete menu choices.

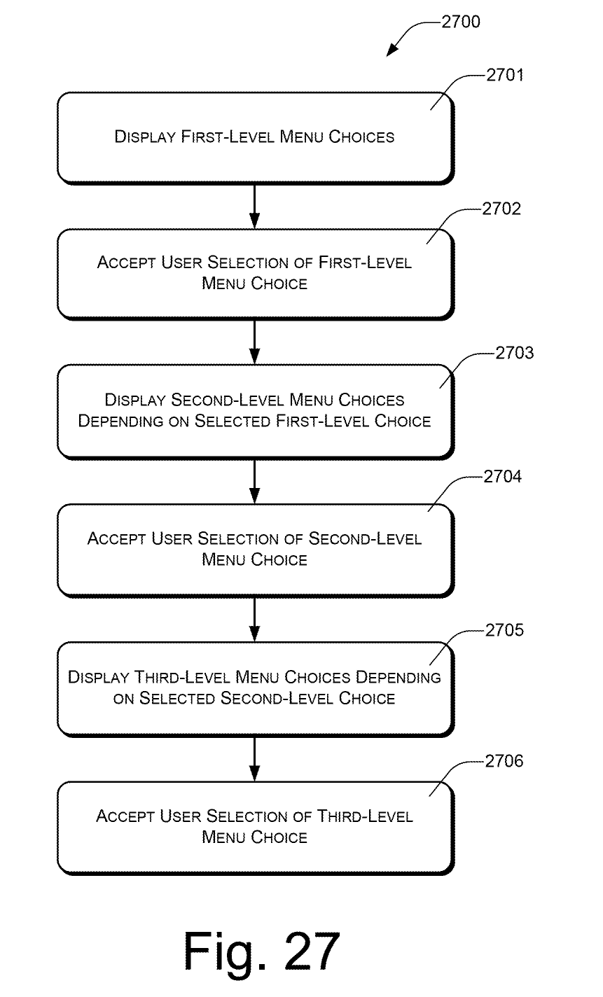

FIG. 30 shows another example of a device that can be used with a multi-region touchpad. This example is a tablet or other handheld computer 3000 having a touch-screen display 3001. Some tablet computers may have functionality similar to a general-purpose desktop or laptop computer, but in a relatively thin form factor. Other tablet computers may have more limited functionality, and be designed for specific tasks.

Many tablet computers do not have a full hardware alphanumeric keyboard, relying instead on virtual keyboards displayed on touch-screen display 3001. A limited number of buttons or keys 3002 may be used for basic functionality.

Touch-screen display 3001 may be sensitive to touch, using capacitive or resistive technology, to detect the touch of a finger. Alternatively, or in addition, touch-screen display 3001 may employ an active digitizer for use in conjunction with a stylus. Other embodiments may use other types of user input that do not necessarily include touch input.

A hierarchical or multi-region touchpad 3003 may be positioned on the front of tablet computer 3000 to provide one means of user input. Multi-region touchpad 3003 can be used to perform various contextually-dependent operations in accordance with different the usage scenarios described above. A menu 3004, corresponding in shape to multi-region touchpad 3003, may be displayed on touch-screen display 3001 to indicate current choices available to a user via multi-region touchpad 3003.

Multi-region touchpad 3003 can be receptive to finger touch, to stylus touch, or both. Although touchpad 3003 is shown as being circular, other shapes might be utilized to provide better tactile feedback and to allow easier identification of a “home” or default position.

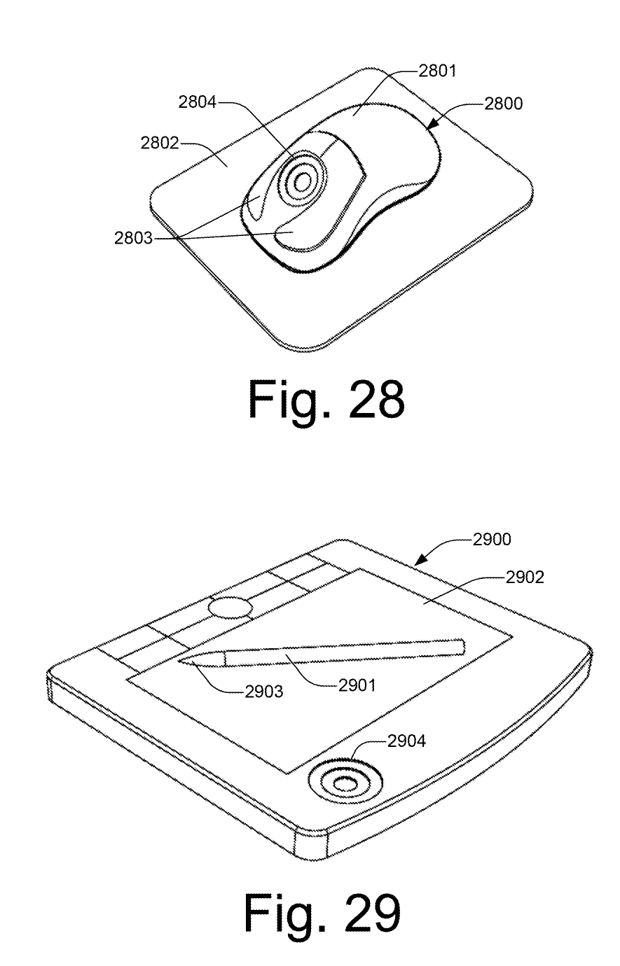

FIG. 31 shows another example: a remote control 3100 such as might be used to control a television, stereo system, or other system. A remote control such as this typically uses radio or infrared frequencies to communicate with different controlled devices and includes a number of physical buttons 3101 or other control elements that a user presses to designate different actions. Although not shown in this embodiment, some remote controls might include a small display, and some might include a touch-sensitive display that might replace many of buttons 3101.

A multi-region touchpad 3102 can be positioned on the operating surface of remote control 3100 for operation by a user's thumb or other finger. Multi-region touchpad 3102 can be used in conjunction with a menu structure that is displayed on a graphical or video component of the system being controlled, such as on a television screen. Alternatively, multi-region touchpad 3102 might be used in conjunction with a touch-screen that is part of the remote control itself. Note also that touchpad 3102 can also be placed on the rear of remote control 3100.

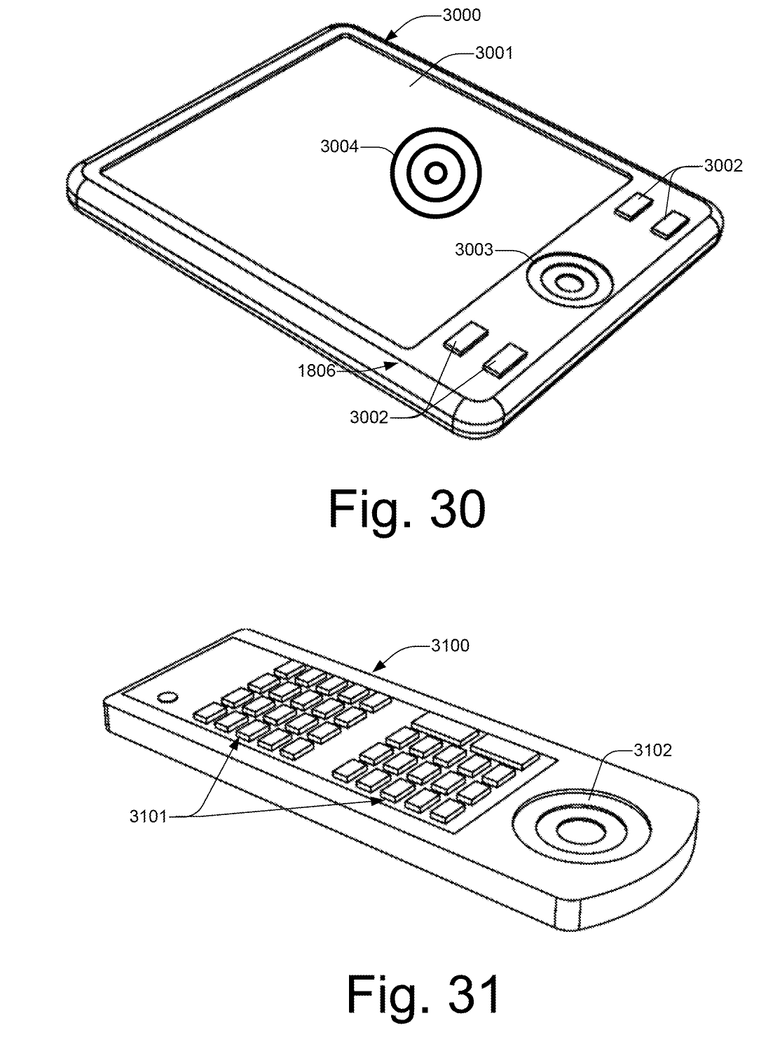

FIG. 32 shows a game controller 3200 as yet another example of a device that can utilize a multi-region touchpad. A game controller typically operates in conjunction with dedicated video game consoles or other computerized gaming devices to interface with a user and to allow the user to control aspects of game play that are presented on some form of video display. In this example, the controller has a number of buttons or other control elements 3201. In addition, a multi-region touchpad 3202 can be positioned at a convenient location on the top, side, or bottom of controller 3200 for use in accordance with the usage scenarios described above.

Touchpad 3202 can be used in conjunction with menus displayed or overlaid on the video game display to select options and to allow quick, on-the-fly selection of various aspects of game play. For example, an inner touch band might be used to allow the player to select from different items of inventory, while an outer touch band is used to allow the player to select different weapons. As another example, an inner touch band might be used to specify an action or verb to perform in the game, while a dependent outer touch band is used to specify items that might be available as the object of that action or verb. A combination of three touch bands might be used to indicate a tool, an action to perform with the tool, and an object of the action. More than one multi-region touchpad might be used on a single controller, allowing convenient access to a greater number of game functions.

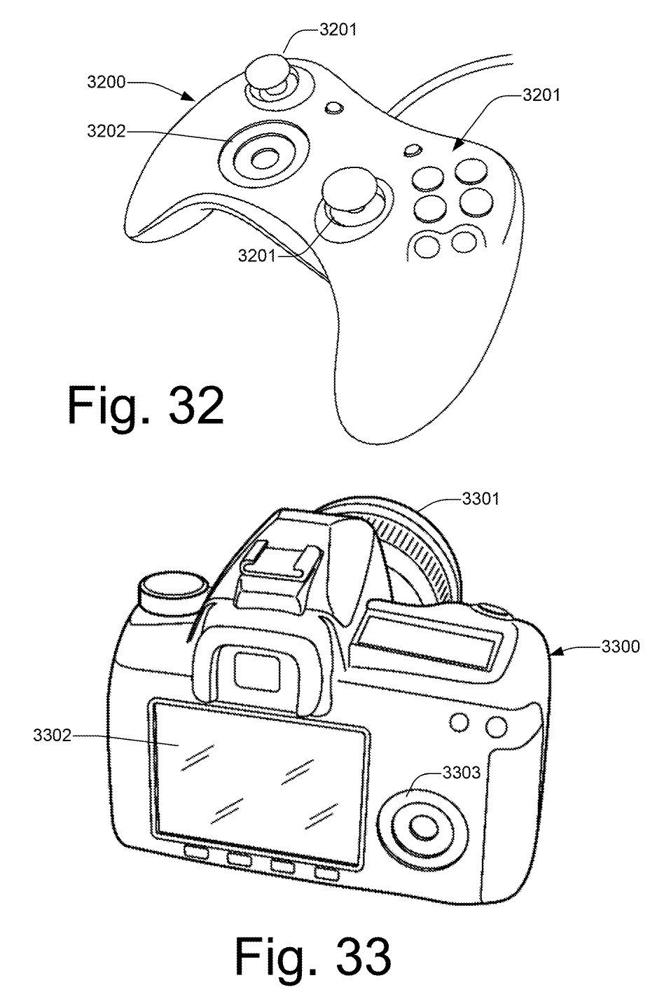

FIG. 33 shows a digital camera 3300 as an example of a device that can utilize a multi-region touchpad. Digital camera 3300 has a lens 3301 an internal image sensor (not shown), as well as various mechanical, electrical, and optical controls that are used to capture still and/or moving images. The illustrated example also has an LCD (liquid-crystal display) 3302 or other flat-screen display that is used for previewing images, for displaying captured images, and for user interaction to set various operational parameters.

A multi-region touchpad 3303 is positioned on the back of camera 3300, adjacent display 3302. Touchpad 3303 can be used in conjunction with display 3302 in accordance with many of the techniques described above to set operational parameters of the camera, including exposure parameters. As an example, an inner touch band of touchpad 3303 can be used to set exposure length, while an outer touch band is used to select aperture. Another touch band might be used to select equivalent film speed.

Touchpad 3303 might be dedicated to controlling specific camera/exposure parameters, or might be used in a contextually dependent fashion to control many different parameters. Furthermore, touchpad 3303 might be used without an associated display, and might be positioned differently, such as on the front of camera 3300.

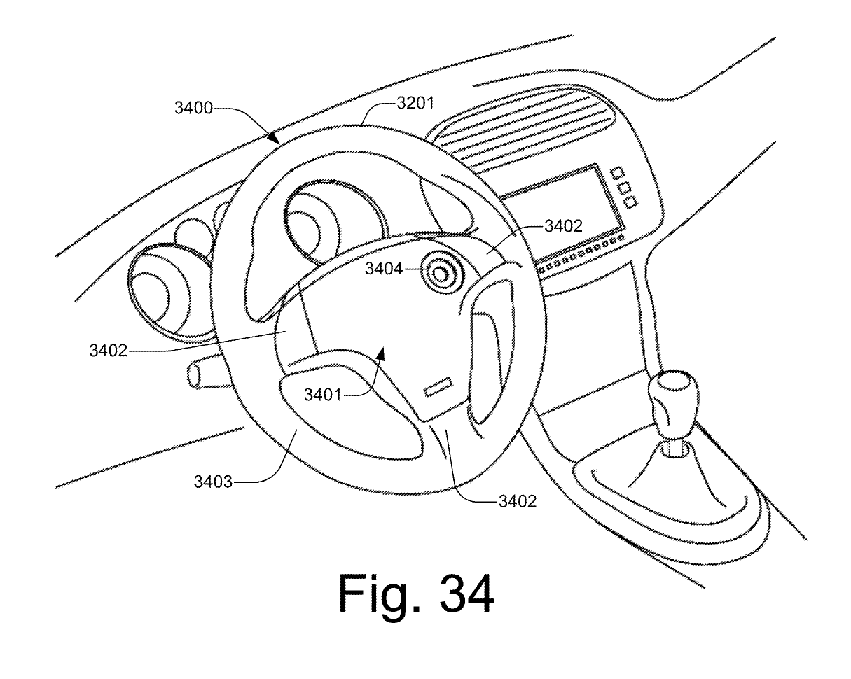

FIG. 34 show another example of a control device that might incorporate a multi-region touchpad such as described herein. This example comprises an automotive steering wheel 3400 such as commonly used in automobiles and other vehicles. Steering wheel 3400 includes a hub 3401, one or more spokes 3402, and a rim 3403 that is grasped by a driver to rotate the steering wheel. A multi-region touchpad 3404 is positioned on hub 3401 or one of the spokes 3402, adjacent rim 3403, so that it can be accessed by the thumb or finger of the driver. Note that although touchpad 3404 is shown on the side of the steering wheel facing the driver, it might also be located on the side of the steering wheel facing away from the driver. The touchpad 3404 can also be located in different locations within the vehicle, such as on various other primary controls that are grasped by a driver to control different aspects of vehicle operation and navigation. For example, the touchpad 3404 might be positioned on the top or end of a shift lever or some other physical vehicle control that is operated by a hand.

Touchpad 3404 can be used with various vehicle control systems to set various operational parameters of a vehicle or to interact with on-board systems such as entertainment systems or route guidance systems. Menus can be presented on a so-called “heads-up” display, as transparent images on the vehicle windshield, within the driver's normal line of sight. This allows the driver to interact with vehicle subsystems without looking away from the road. Additionally, the position and tactile nature of touchpad 3404 allows the driver to navigate various menus without moving their hand from the steering wheel. Touch bands corresponding to different menu levels are easily identified by tactile differentiation, while positions within each level are easily located by their correspondence in shape with displayed menu structures.

The embodiments described above may be implemented using various different means of operational logic, including the architecture illustrated by FIG. 17.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

Further, it should be noted that the system configurations illustrated above are purely exemplary of systems in which the implementations may be provided, and the implementations are not limited to the particular hardware configurations illustrated. In the description, numerous details are set forth for purposes of explanation in order to provide a thorough understanding of the disclosure. However, it will be apparent to one skilled in the art that not all of these specific details are required.

We claim:

1. An input device for use with a graphical user interface, comprising:
at least one control mechanism allowing a user to manipulate an element on the graphical user interface; and
a touchpad having a plurality of tactually-delineated touch bands surrounding a central area.

2. An input device as recited in claim 1, wherein:
the touch bands are successively nested; and
each successively inward touch band is stepped down in elevation to form a concavity.

3. A device as recited in claim 1, further comprising a body that is moveable over a surface to move a cursor on the graphical user interface.

4. A device as recited in claim 1, further comprising a digitizer, wherein the at least one control mechanism comprises a stylus that can be used with the digitizer to manipulate the element on the graphical user interface.

5. A computer mouse comprising:
a body that is moveable over a surface to move a cursor on the graphical user interface; and
a touchpad positioned on the body for access by a user's finger, the touchpad having a plurality of tactually-delineated touch bands that surround a central area.

6. A computer mouse as recited in claim 5, wherein:
the touch bands are successively nested; and
each successively inward touch band is stepped down in elevation to form a concavity in the body.

7. A controller for use with a controlled system, comprising:
a touch sensor; and
the touch sensor having a plurality of successively nested touch bands surrounding a central area, the touch bands being tactually delineated from each other.

8. A controller as recited in claim 7, wherein the controller is an entertainment system remote control.

9. A controller as recited in claim 7, wherein the controller is a game controller.

10. A controller as recited in claim 7, each successively inward touch band is stepped down in elevation to form a concavity.

11. A computer keyboard, comprising:
keys that are operable by a user to enter text on a computer; and
a touchpad positioned relative to the keys for access by a user's finger, the touchpad having a plurality of adjacent touch-sensitive areas that are tactually delineated from each other and that surround a central area.

12. A computer keyboard as recited in claim 11, wherein the touch-sensitive areas comprise successively nested touch bands surrounding the central area.

13. A computer keyboard as recited in claim 11, the touch-sensitive areas comprising successively nested touch bands surrounding the central area; and
each successively inward touch band is stepped down in elevation to form a concavity.

14. A camera, comprising:
a camera lens;
an image sensor to capture optical images through the camera lens;
a display that displays the optical images;
a touch input sensor having a plurality of successively nested touch bands that are tactually delineated from each other and that surround a central area; and
operational logic that is responsive to the touch input sensor to set operating parameters of the camera.

15. A camera as recited in claim 14, wherein the operational logic is responsive to the touch input sensor to set exposure parameters used by the camera when capturing optical images.

16. A camera as recited in claim 14, wherein each successively inward touch band is stepped down in elevation to form a concavity.

17. A camera as recited in claim 14, wherein the touch bands are concentric.

18. A vehicle control system for use by a driver in a vehicle, comprising:
a primary control that is grasped by a driver during operation of the vehicle to control an aspect of vehicle operation; and
a touchpad positioned relative to the primary control for touching by the driver while grasping the primary control, the touchpad having a plurality of adjacent touch-sensitive areas that are tactually delineated from each other and that surround a central area.

19. A vehicle control system as recited in claim 18, wherein:
the touch-sensitive areas are concentric; and
each successively inward touch-sensitive area is stepped down in elevation to form a concavity.

20. A vehicle control system as recited in claim 18, wherein the primary control comprises a steering wheel.

21. A vehicle control system as recited in claim 20, wherein the steering wheel comprises a rim that is graspable by the driver to rotate the steering wheel; and

22. A vehicle control system as recited in claim 20, wherein the touchpad is positioned to face the driver.

23. A vehicle control system as recited in claim 20, wherein the touchpad is positioned to face away from the driver.

24. A vehicle control system as recited in claim 20, further comprising a spoke, wherein the touchpad is positioned on the spoke.
